(19) United States
(12) Patent Application Publication
(10) Pub. No.: US 2025/0205636 A1
(43) Pub. Date: Jun. 26, 2025

(54) Method for recovering methane and carbon dioxide from biogas

(71) Applicant: Airco Process Technology A/S, Fredericia (DK)

(72) Inventors: Rasmus Find, Fredericia (DK); Niels Zöga Rytter LARSEN, Fredericia (DK); Jan Flensted POULSEN, Fredericia (DK)

(73) Assignee: Airco Process Technology A/S, Fredericia (DK)

(21) Appl. No.: 18/848,385

(22) PCT Filed: Mar. 24, 2023
(86) PCT No.: PCT/EP2023/057678

§ 371 Date: Sep. 18, 2024

(30) Foreign Application Priority Data
Mar. 24, 2022 (EP) 22164132.7

(51) Int. Cl. B01D 53/14

(52) U.S. Cl. CPC B01D 53/1475; B01D 53/1425; B01D 53/1493; B01D 2252/103; B01D 2256/245; B01D 2258/05

(57) ABSTRACT

The present invention relates to methods for treating biogas to provide an upgraded biogas and a purified carbon dioxide product, combining biogas upgrading processes using physical absorption with a carbon dioxide liquefaction process. The present invention relates to methods for providing a carbon dioxide-rich intermediate from the biogas upgrading process which is suitable for carbon dioxide liquefaction. The method further relates to methods for recovering carbon dioxide and/or methane in the liquefaction process

### CROSS-REFERENCE TO RELATED APPLICATIONS

The instant application is a U.S. National Stage application of and claims priority to PCT/EP2023/057678, filed on Mar. 24, 2023, which is a PCT application of and claims priority to EP Application Serial No. 22164132.7, filed on Mar. 24, 2022, the subject matter of both aforementioned applications is hereby incorporated by reference in their entireties.

### FIELD OF THE INVENTION

The present invention relates to methods for treating biogas to provide an upgraded biogas and a purified carbon dioxide product, specifically to absorption processes using physical absorbents.

### BACKGROUND

Biogas is a renewable energy source which is derived from industrial microbial decomposition of various carbon sources from for example, landfills, manure, sewage, food production waste or the like. The biogas obtained from these microbial processes does not have sufficient methane purity for industrial use and hence biogas feeds are upgraded to what may be referred to as biomethane or upgraded biogas. Upgrading processes remove undesired components from the biogas feed, namely carbon dioxide, water, hydrogen sulphide and possibly traces of volatile organic compounds (VOC). The main impurity is carbon dioxide the content of which may be more than 20 percent by volume in biogas feeds and such as in the range of 20 to 60 percent. The upgraded biogas is the main product of upgrading processes and the carbon dioxide is typically vented to the atmosphere. However, there is an increasing interest in utilizing carbon dioxide for various industrial purposes such as power-to-X rather than emitting it to the atmosphere. To utilize the carbon dioxide, it should preferably be provided with high purity carbon dioxide and in condensed form, typically liquid, which is practical and efficient with respect to storage and transport. Carbon dioxide liquefaction processes combine a series of compression and cooling operations to condense the carbon dioxide, and the efficiency of the process, energy use per unit carbon dioxide product, increases with the carbon dioxide purity of the liquefaction feed. Hence, the carbon dioxide removed from biogas feeds in upgrading processes can be a side product of biogas upgrading processes, if the carbon dioxide can be recovered at high purity and high recovery rates from the biogas process in an economically efficient manner.

The biogas upgrading processes may be absorption processes where the impurities are absorbed in liquid absorbent which is regenerated to remove carbon dioxide and then re-used in the absorption step. One type of absorption processes uses physical absorbents, such as water, where carbon dioxide is dissolved in the absorbent according to its solubility at a given operating pressure. Elevated pressures are used to increase the solubility of the gas in the absorbent, reducing the flow of absorbent. The loaded physical absorbent is then regenerated at lower pressures, sometimes with a stripping gas, typically air, providing cost-efficient regeneration of the absorbent. However, regenerating by stripping dilutes the resulting off-gas making it uneconomical to process it further to a purified carbon dioxide product.

An example of such a process is shown in WO2021/254980A1 to the same applicant, which discloses a method for upgrading biogas using physical absorption where the methane slip, i.e. the methane not recovered in the upgraded biogas, is reduced by a series of combined absorption and depressurisation steps performed on the loaded physical absorbent, but wherein the physical absorbent is regenerated for re-use by stripping with air. The carbon dioxide released in the stripper is thus diluted with air, which makes any subsequent purification thereof costly.

US2010/0135892A1 is not concerned with upgrading biogas but discloses a process for recovering carbon dioxide from natural gas at high purity. In this process, the gas feed contains 1 to 10% carbon dioxide which is absorbed by physical absorption. The loaded absorbent is in this process regenerated by heat to release the carbon dioxide at high purity. Such processes may be useful for relatively pure gas feeds where the liquid flow per unit gas product is correspondingly low.

For biogas feeds having a much higher carbon dioxide content, the amount of physical absorbent recirculated per unit upgraded biogas produced will be greater and regenerating the large quantities of absorbent by heating is not cost-effective.

Hence, it is an object of the present invention to provide improved or alternative methods for treating a biogas feed to provide both an upgraded biogas and a purified carbon dioxide product, which are cost-effective. The methods may be more efficient by achieving both high recovery rates and high purity of both methane and carbon dioxide efficiently in terms of utility consumption and/or equipment use. A further object of the invention is to provide integrated biogas upgrade and carbon-dioxide liquefaction processes.

### SUMMARY OF THE INVENTION

These and other objects are achieved by a first aspect of the invention, providing a method for treating a biogas feed comprising methane and carbon dioxide to provide an upgraded biogas and purified carbon dioxide product, which method comprises the steps of
i) in a first absorption step, contacting the biogas feed with a first absorbent in a first absorber thereby providing an enriched biogas and a loaded first absorbent, the loaded first absorbent having a higher content of carbon dioxide than the first absorbent,
ii) in a vacuum desorption step, feeding the loaded first absorbent to a low-pressure desorption unit with an operating pressure which is lower than ambient pressure, thereby providing a carbon dioxide-rich intermediate and a lean first absorbent, and optionally,
iii) in a liquefaction step, liquifying the carbon dioxide-rich intermediate in a liquefaction process thereby providing the purified carbon dioxide product and a non-condensed portion,
wherein the first absorbent is a physical absorbent, preferably water, and further wherein the first absorbent is obtained from the lean first absorbent.

By recovering carbon dioxide in the vacuum desorption step, a high carbon dioxide recovery rate can be achieved while providing carbon dioxide intermediate with a high carbon dioxide purity, which can then be efficiently liquefied in the liquefaction process. The upgraded biogas is obtained from the enriched biogas, and as will be described in greater detail below with respect to specific embodiments, the enriched biogas is in some embodiments of the invention subjected to further absorption steps to provide the upgraded biogas, while in other embodiments the upgraded biogas is obtained as the enriched biogas from the first absorber. The carbon dioxide is removed from the feed biogas in the first absorber by contact to the first absorbent at elevated pressures, for example, greater than 5 bar(a), providing the loaded first absorbent. The loaded first absorbent contains carbon dioxide and the carbon dioxide-rich intermediate is obtained by subjecting the physical absorbent to a vacuum desorption step. The first absorbent used in the first absorber is obtained from the lean first absorbent obtained in the vacuum desorption step either directly as a portion of the lean first absorbent or after further removal of carbon dioxide from the lean first absorbent.

The first absorption step is carried out at elevated pressures at or exceeding 5 bar(a), such as in the range 5 to 30 bar(a). The absorption step(s) of the invention are designed to yield an upgraded biogas process of grid-level quality, for example, having a methane purity at or above 95 mol % on dry basis, preferably above 97 mol % or above 98 mol %. The skilled practitioner is able to design the absorption step(s) to achieve these targets, for example, by selecting the gas-liquid ratio and height of the absorber(s).

The methods according to the invention may preferably use water as the physical absorbent. Hence, the first and second physical absorbent is preferably water.

Liquefaction processes are known to the skilled person and comprise a series of compression steps, cooling steps and expansion steps to achieve high pressure and low temperatures to condense the carbon dioxide. In a condensation step of the liquefaction step the treated gas is cooled below the vapour-liquid equilibrium at high pressures, typically close to the triple point of carbon dioxide, condensing the carbon dioxide to liquid and leaving the non-condensed portion. The liquid carbon dioxide is typically purified by stripping to remove contaminants. An example of a carbon dioxide process which is suitable is presented in greater detail in the detailed description.

In a preferred embodiment, the liquefaction process comprises the steps of:
l1) pressurizing the carbon dioxide-rich intermediate to provide a pressurized carbon dioxide rich stream,
l2) cooling the pressurized carbon dioxide rich stream in a condenser to provide a condensed portion and the non-condensed portion,
l3) distilling the condensed portion in a distillation column having a reboiler to provide a top portion, which top portion is sent to the condenser of step l2) for condensation, and the purified carbon dioxide product as a bottoms portion, which the purified carbon dioxide product is at least partly sent to the reboiler.

The reboiler of the distillation column thus generates the stripping gas for the distillation column from the bottoms portion. The reboiler of the distillation column may use the pressurized carbon dioxide rich stream obtained in step l1) to heat the bottoms portion, which is sent to the reboiler, thereby cooling the pressurized carbon dioxide rich stream prior to condensation in step l2). Step l1) may comprise one or more compressor stages, cooling in one or more chillers and separation of condensed water in one or more separation vessels. Specific embodiments of the invention are described below which may improve on the methane recovery rate and/or carbon dioxide recovery rate of the process or efficiency of the process. In some embodiments, this is achieved by improving the quality and/or amount of the carbon dioxide-rich intermediate, which is sent to the liquefaction process, and in other embodiments it is achieved by integrating the biogas upgrading process with the liquefaction process by recovering and recycling methane and/or carbon dioxide from the liquefaction process and back into the biogas upgrading process.

In some embodiments, the method further comprises a step of: in a first methane recovery step, recovering methane from the loaded first absorbent prior to the vacuum desorption step ii), providing a first recovered methane portion and a methane-lean loaded first absorbent, wherein the methane-lean loaded first absorbent replaces the loaded first absorbent in the vacuum desorption step ii) and has lower content of methane than the loaded first absorbent. The first recovered methane portion can be recycled into the first absorber, or if its methane purity is high, directly into enriched biogas.

As the first absorption is performed at elevated pressure, methane will also be absorbed in the loaded first absorbent, and especially for biogas feeds having a high content of carbon dioxide which thus requires a large flow of first absorbent, the methane content of the loaded first absorbent can be significant. Recovering methane from the biogas serves the dual purpose of increasing the methane recovery of the method and reducing the amount of methane present in the carbon-dioxide rich intermediate, thus improving the quality of the feed to the liquefaction process.

In some embodiments, the first methane recovery step comprises flashing the loaded first absorbent providing the first recovered methane portion and the methane-lean loaded first absorbent, the methane-lean loaded first absorbent having lower content of methane than the loaded first absorbent.

The pressure difference between the first absorber and the vacuum desorption unit, can be used for one or more flash separations of the loaded first absorbent as the first methane recovery step. Such flash separations provide simple and inexpensive processes for recovering methane in terms of equipment but may still leave some methane in the carbon dioxide-rich intermediate in the non-condensed portion obtained from the liquefaction process. Accordingly, the non-condensed portion obtained from the liquefaction process may advantageously be recycled from the liquefaction process to the first absorber. In this way, methane and carbon dioxide in the non-condensed portion is recovered.

In some embodiments, the first methane recovery step comprises: flashing the loaded first absorbent in a methane recovery unit and contacting the resulting liquid portion with an intermediate recovered gas in the methane recovery unit, obtaining, from the methane recovery unit, the first recovered methane portion and an intermediate methane-lean loaded first absorbent, flashing the intermediate methane-lean loaded first absorbent thereby providing the methane-lean first absorbent and the intermediate recovered gas, pressurizing and feeding the intermediate recovered gas to the methane recovery unit.

In a further development of the preceding embodiment, the first methane recovery step further comprises: contacting the gas of methane recovery unit with an intermediate absorbent providing the first recovered methane portion, wherein the intermediate absorbent is obtained from the lean first absorbent.

Using such methane recovery units with intermediate gas and possibly intermediate absorbents, improves the amount of methane recovered from the loaded first absorbent compared to flash separations as described above. Hence the amount of methane in the carbon dioxide-rich intermediate and in the non-condensed portion will also be reduced, while still providing high methane recovery rates. With low amounts of methane in the non-condensed portion, there is no need for recycling the non-condensed portion back to the absorption step, which allows for alternative processes for recovering carbon dioxide from the non-condensed portion, such as a post-liquefaction absorber as will be described in greater detail below.

In some embodiments, the vacuum desorption step ii) comprises contacting the loaded first absorbent, or methane-lean loaded absorbent if present, with a strip gas in the low-pressure desorption unit providing the carbon dioxide-rich intermediate and the lean first absorbent, the carbon dioxide-rich intermediate having a higher content of carbon dioxide than the strip gas.

The amount of carbon dioxide recovered in the carbon dioxide rich intermediate is improved by using strip gas in the low-pressure desorption unit. The amount of strip gas is preferably kept low so as not to dilute the carbon dioxide-rich intermediate, hence a ratio of gas flow to liquid flow in the low-pressure desorption unit may be less than 5%, preferably less than 1%, more preferably less than 0.1%. Ratios of gas flow to liquid flow as used herein refer to mole percentages unless otherwise specified. More generally, the low-pressure desorption unit is designed to achieve a carbon dioxide content in the carbon dioxide rich intermediate of at least 80 mol %, preferably at least 90 mol % and more preferably 95 mol %. Simultaneously, the amount of carbon dioxide removed from the liquid in the low-pressure desorption unit is at least 40% of the amount required reach the carbon dioxide concentration of the first absorbent which is fed to the first absorber, preferably at least 50%, more preferably at least 60%, even more preferably at least 80%. This is achieved by adjusting the vacuum level, amount of strip gas, and height of the low-pressure desorption unit.

In some embodiments, the strip gas of step ii) is obtained by flashing the loaded first absorbent, or the methane-lean loaded first absorbent if present, upstream of the low-pressure desorption unit.

This may be especially advantageous when the non-condensed portion obtained from the liquefaction process is recycled to the first absorber, since obtaining the strip gas from the loaded first absorbent, or methane-lean loaded first absorbent, does not introduce external gas into the process which should otherwise be removed elsewhere. When the strip gas is obtained by flashing the (methane-lean) loaded first absorbent, the residual liquid obtained is sent to the low-pressure desorption unit.

External gas as used herein, refers to gas supplied from a source which is external from the biogas upgrading process and liquefaction process, such as an external air supply or external nitrogen supply. By using strip gas obtained from the loaded first absorbent, the non-condensed portion which is obtained from the liquefaction process can be recycled back into the biogas upgrading process, without contaminating the biogas upgrading process with external gas. Generating the strip gas from the (methane-lean) loaded first absorbent, may be achieved by reducing the pressure to a pressure in the range of 1 bara to about 3 bara. Reducing to a pressure above atmospheric, may be advantageous to maintain some energy for propelling the gas to the low-pressure desorption unit.

In some embodiments, the strip gas of step ii) is a gas which allows carbon dioxide to be stripped in the low-pressure desorption unit such as air, nitrogen, or methane

These embodiments may use gas, for example, air or nitrogen, from an external source to increase the amount carbon dioxide in the carbon dioxide rich intermediate and thus the overall recovery of carbon dioxide. This provides more flexibility in adjusting the strip gas amount, compared to embodiments where the strip gas is obtained by flashing the (methane lean) loaded first absorbent. Using air as the strip gas also introduces oxygen into the carbon dioxide rich intermediate, which oxygen can be used to remove sulphur compounds, if present, in sulphur oxidation processes which are well known to the skilled practitioner. It may be especially advantageous to use an external gas in embodiments where the first methane recovery step employs a methane recovery unit as described above. The methane recovery unit provides a carbon dioxide-rich intermediate and a non-condensed portion with low amounts of methane, whereby recycling the non-condensed portion to the first absorber is less beneficial, and therefore the external gas introduced by the strip gas is not recycled into the process. The non-condensed portion may in these embodiments advantageously be treated in a post-liquefaction absorption step to recover the carbon dioxide left in the non-condensed portion, as will be described in greater detail below. Alternatively, methane may be used as strip gas of step ii), for example by using a portion of the enriched biogas or upgraded biogas as the strip gas. When using methane as the strip gas, the non-condensed portion obtained from the liquefaction process is advantageously recycled to the first absorber to recover the methane again. The skilled practitioner understands that a gas which allows carbon dioxide to be stripped in the low-pressure desorption unit, is a gas having a lower partial pressure of carbon dioxide than the carbon dioxide vapour pressure of the liquid in the low-pressure desorption unit, which thus allows for additional carbon dioxide to transfer into the gas phase.

In some embodiments, the method comprises liquefaction step iii) and further comprises recycling the non-condensed portion to the first absorber.

Generally, recycling the non-condensed portion to the first absorber recovers any methane and carbon dioxide left in the non-condensed portion. Hence, it is most beneficial for embodiments wherein the methane content of the carbon dioxide-rich intermediate is high, for example because there is no first methane recovery step, or there is a first methane recovery step, but it leaves a significant amount of methane in the carbon dioxide rich intermediate. In this context, it will typically be advantageous to recycle the non-condensed portion to the first absorber, if the methane slip is at greater than 0.5%, or, at or greater than 2%, the methane slip being the ratio of the difference in methane content (kg/hr) of the biogas feed and the upgraded biogas (numerator) and the methane content of the biogas feed (kg/hr) (denominator).

In some embodiments, the method comprises liquefaction step iii) and further comprises the steps of: in a post-liquefaction absorption step, contacting the non-condensed portion obtained in step iii) with a third absorbent in a post-liquefaction absorber thereby providing a washed non-condensed portion and a loaded third absorbent, the washed non-condensed portion having a lower content of carbon dioxide than the non-condensed portion, and either obtaining the third absorbent from the lean first absorbent and recycling the loaded third absorbent to the low-pressure desorption unit, or contacting the loaded third absorbent with the carbon dioxide rich intermediate in a pre-liquefaction stripper, thereby providing the third absorbent and an enriched liquefaction feed for use in the liquefaction step iii).

The post-liquefaction absorption step increases the carbon dioxide recovery by absorbing carbon dioxide from the non-condensed portion into the third absorbent and recycling the loaded third absorbent thus obtained back to the feed to the liquefaction process, the carbon dioxide-rich intermediate. In some embodiments the recycle is achieved by stripping the loaded third absorbent in the low-pressure desorption unit of step ii) and obtaining the third absorbent from the lean first absorbent. As mentioned above, the post-liquefaction step may be especially suited for embodiments with a low-content of methane in the carbon-dioxide rich intermediate, which can be achieved by including a first methane recovery step employing methane intermediate gas and possibly intermediate absorbent in the methane recovery unit as previously described.

In some embodiments, the enriched biogas obtained in step i) is the upgraded biogas and wherein the method further comprises the steps of:
iv) in a first stripping step, contacting the lean first absorbent obtained from step ii) with a first strip gas in a first stripper thereby providing a spent first strip gas and regenerated first absorbent,
wherein the first absorbent is a portion of the regenerated first absorbent and the intermediate absorbent, if present, and/or the third absorbent, if present, is/are (a) further portion(s) of the regenerated first absorbent.

The low-pressure desorption unit serves to recover carbon dioxide from the loaded first absorbent at high purity making the obtained gas efficient to process further in the liquefaction unit. The subsequent first stripper serves to remove carbon dioxide left in the lean first absorbent obtained from the vacuum desorption step, providing the regenerated first absorbent, thereby increasing the capacity of the first absorbent for absorbing carbon dioxide. In this way, the first stripper reduces the circulation of first absorbent. The spent first strip gas is typically vented, and hence the first stripper can be operated with large flows of the first strip gas, providing a cost-effective removal of residual carbon dioxide. The first stripper is advantageously used in the embodiments where the first absorber is designed to provide the enriched gas at the desired methane purity, i.e., as the upgraded biogas. The operating pressure of the first stripper will typically be at substantially atmospheric pressure. The first strip gas is suitably air. A total amount of carbon dioxide is removed by the low-pressure desorption unit and the first stripper to provide the regenerated first absorbent. Of this total amount carbon dioxide removed, the low-pressure desorption unit removes at least 50% of the carbon dioxide, such as at least 60%, 70%, 80%, 85% or even at least 90%.

In some embodiments, the first strip gas is at least a portion of the first recovered methane portion and the spent first strip gas is recycled to the first absorber. Alternatively, a portion of the upgraded biogas can be used as the first strip gas.

In this way the carbon dioxide recovery rate is improved further as the residual carbon dioxide in the lean first absorbent obtained from the low-pressure desorption unit is recycled with the spent first strip gas. This may advantageously be combined with first methane recovery steps using the first methane recovery unit with intermediate gas and possible intermediate absorbent, as previously described, providing first recovered methane portion with high methane purity and thus low carbon dioxide content, which is advantageous for stripping carbon dioxide. If in such an embodiment, the non-condensed portion obtained from the liquefaction process is recycled to the first absorber, a process with no venting of gas portions can be provided, increasing the recovery rates of carbon dioxide and methane. The loss of carbon dioxide and methane will be limited to the accepted impurity of the upgraded biogas and purified carbon dioxide product and the small amounts lost, for example, in liquid fractions separated from the gas in the process, such as condensed water.

In some embodiments, the method further comprises the steps of:
v) in a second absorption step, contacting the enriched biogas obtained in step i) with a second absorbent in a second absorber providing the upgraded biogas and a loaded second absorbent,
vi) in a second methane recovery step, recovering methane from the loaded second absorbent obtained in step v) providing a second recovered methane portion and a methane-lean loaded second absorbent, and
vii) in a second stripping step, contacting the methane-lean loaded second absorbent with a second strip gas in a second stripper providing a spent second strip gas and a regenerated second absorbent, wherein the spent second strip gas has a higher content of carbon dioxide than the second strip gas,
wherein the second absorbent is a physical absorbent and is obtained from the regenerated second absorbent.

Two absorbers may be used to upgrade biogas, which allows for separate pressures in absorber sections, i.e. a higher pressure in the second absorber, which can reduce the carbon dioxide content of the upgraded biogas. It is contemplated that this embodiment of the invention can be used when retrofitting an existing two-stage absorption process, to recover carbon dioxide from absorbent.

In such two-stage embodiments, the first absorbent, intermediate absorbent, if present, and third absorbent, if present, may be obtained from the low-pressure desorption unit as (a) portion(s) of the lean first absorbent. The second absorbent used in the second absorbent is regenerated separately in the second stripper. The second absorbent is a physical absorbent and preferably the same as the first absorbent. The first and second absorbers may be two sections of the same absorber unit. The term “absorber” as used herein refers to a unit which is supplied with fresh absorbent, and from which loaded absorbent is retrieved. Hence two absorbers are each supplied with a fresh absorbent and a loaded absorbent is retrieved from each absorber. Two absorbers may thus be two sections of the same absorption column. A total absorbent flow in two-stage processes is the sum of the first absorbent and the second absorbent. Typically, the first absorbent be majority of the total absorbent flow, as carbon dioxide is recovered from the loaded first absorbent. Hence, the first absorbent may be at least 50% of the total absorbent flow, such as at least 55%, at least 60%, at least 65% or at least 70%.

The second methane recovery step can be of the same configuration as described above for the first methane recovery step. Hence in some embodiments, the second methane recovery step vi) comprises: flashing the loaded second absorbent into a second methane recovery unit and contacting the resulting liquid portion with a second intermediate recovered gas in the second methane recovery unit, obtaining, from the second methane recovery unit, the second recovered methane portion and a second intermediate methane-lean loaded second absorbent, flashing the second intermediate methane-lean loaded second absorbent thereby providing the methane-lean second absorbent and the second intermediate recovered gas, pressurizing and feeding the second intermediate recovered gas to the second methane recovery unit. In a further development, the second methane recovery step vi) further comprises: contacting the gas of the second methane recovery unit with a second intermediate absorbent providing the second recovered methane portion, wherein the second intermediate absorbent is obtained from the regenerated second absorbent.

In some embodiments, the second methane recovery step may further comprise contacting the liquid obtained by flashing the loaded second solvent with a gas stream to strip methane from the liquid into the second recovered methane portion, such as nitrogen or a gas obtained by flashing the loaded first absorbent.

The second recovered methane portion may be recycled to the first absorber or second absorber, or, if the methane purity allows it, to the upgraded biogas.

In some embodiments the second strip gas is air and the spent second strip gas is vented. In alternative embodiments, the second strip gas is a portion of the upgraded biogas or of the enriched biogas and the spent second strip gas is recycled to the first or second absorber.

In some embodiments, the operating pressure of the low-pressure desorption unit is less than 0.9 bar(a), preferably less than 0.8 bar(a), less than 0.7 bar(a), 0.5 bar(a), most preferably less than 0.1 bar(a). The carbon dioxide recovery rate will improve by lowering the pressure; hence the desired operating pressure may be chosen to balance the value of the recovered carbon dioxide and the energy cost of the vacuum pump.

In all variations of the embodiments described, the methods may further comprise, prior to the first absorption step, a pre-wash step of the biogas feed:
in the pre-wash step, contacting the biogas feed with a pre-wash liquid in a pre-wash unit, thereby providing a spent pre-wash liquid and a washed biogas feed,
wherein the spent pre-wash liquid is discarded or regenerated by heat treatment, the pre-wash liquid is a physical absorbent, and the washed biogas feed is sent to the first absorber. The ratio of gas flow to liquid flow in the pre-washer is typically greater than 200 mol %, preferably greater 400%, based on moles. The pre-wash liquid may be obtained from the lean first absorbent, for example as a portion of the lean first absorbent or of the regenerated first absorbent. In embodiments having a second absorber, the pre-wash liquid may be obtained from the regenerated second absorbent.

By providing the pre-wash step prior to the absorption, water-soluble volatile organic compounds, VOC's are washed from the biogas feed, prior to absorption. As the VOC's are water soluble, they are not or only to a small extent removed with strip gas, and if not removed VOC's may accumulate in the process and serve as a feed for microbial growth, which may result in foaming. Hence, the pre-washer serves to bleed VOCs from the process. Regenerating the spent pre-wash liquid by heat-treatment allows the absorbent, water, to be recycled back into the first absorbent.

In some embodiments, the liquefaction process comprises the steps of pressurizing the carbon dioxide-rich intermediate, cooling the carbon dioxide-rich intermediate, and condensing the carbon dioxide rich intermediate providing the non-condensed and a liquid carbon dioxide stream. The liquid carbon dioxide stream may be the purified carbon dioxide product or may be purified in a stripping step to provide the purified carbon dioxide product.

A system for treating a biogas feed comprising methane and carbon dioxide to provide an upgraded biogas and purified carbon dioxide product is also provided, the system comprising
a biogas production unit, which biogas production unit has a biogas outlet connected to a biogas feed compressor;
a first absorber having a gas inlet fluidly connected to the biogas feed compressor of the biogas production unit, a liquid inlet, a gas outlet and a liquid outlet;
a low-pressure desorption unit having a liquid inlet fluidly connected to the liquid outlet of the first absorber, a gas outlet fluidly connected to a vacuum pump, and liquid outlet fluid connected to the liquid inlet of the first absorber,
a liquefaction system having a condenser, which condenser has a liquid outlet and a gas outlet, and an inlet fluidly connected to the vacuum pump.

Suitably the biogas production unit may be a fermenter, typically an anaerobic digester. The biogas production unit could also be a collection unit collecting biogas from a landfill.

In this way, the system is configured to process a biogas according to the first aspect of the invention. In the following, specific embodiments of the system configured to perform specific embodiments of methods for treating a biogas feed as disclosed herein, is described.

The first absorber is arranged with its gas inlet and liquid outlet at a bottom of the first absorber and with its gas outlet and liquid inlet at a top of the first absorber.

In some embodiments, the system further comprises a first methane flash unit, wherein the liquid outlet of the first absorber is fluidly connected to the liquid inlet of the low-pressure desorption column through a liquid inlet and a liquid outlet of the first methane recovery flash unit, said flash unit further having a gas outlet fluidly connected to the first absorber, optionally trough the biogas feed compressor. The flash unit comprises a valve for reducing pressure.

In a development of the previous embodiment, the system further comprises a first methane recovery unit, wherein the liquid outlet of the first absorber is fluidly connected to the liquid inlet of the first methane flash unit through a liquid inlet and liquid outlet of the methane recovery unit, and the gas outlet of the flash unit is connected to the first absorber through an intermediate compressor and a gas inlet and a gas outlet of the first methane recovery unit. The methane recovery unit is arranged with its liquid inlet and gas outlet at a top of the methane recovery unit, and its liquid outlet and gas inlet at a bottom of the methane recovery unit. The methane recovery unit may have a further liquid inlet fluidly connected to the liquid outlet of the low-pressure desorption unit.

In some embodiments, the low-pressure desorption unit is provided with a gas inlet below the liquid inlet of the low-pressure desorption column, which gas inlet is fluidly connected to a gas source, suitably a source of air or nitrogen. As an alternative to the gas source, the gas inlet is connected to gas outlet of a flash vessel through which flash vessel the liquid outlet of the first absorber is fluidly connected to the liquid inlet of the first absorber. The flash vessel comprises a valve for reducing pressure.

In some embodiments, the gas outlet of the condenser of the liquefaction process is fluidly connected to the first absorber.

In some embodiments, system further comprises a post-liquefaction absorber, and the gas outlet of the condenser of the liquefaction process is fluidly connected to a gas inlet of the post-liquefaction absorber, the post-liquefaction absorber further having a liquid inlet, a gas outlet and liquid outlet. The post-liquefaction absorber is arranged with its gas inlet and liquid outlet at a bottom of the post-liquefaction absorber and with its gas outlet and liquid inlet at a top of the post-liquefaction absorber.

In some embodiments, the liquid inlet of the post liquefaction absorber is fluidly connected to the liquid outlet of the low-pressure desorption unit and the liquid outlet of the post-liquefaction absorber is fluidly connected to the liquid inlet of the low-pressure desorption unit or to a further liquid inlet of the low-pressure desorption unit.

In an alternative embodiment, the system further comprises a pre-liquefaction stripper and the vacuum pump is connected to the condenser of the liquefaction process through a gas inlet and gas outlet of the pre-liquefaction stripper, wherein the liquid inlet of the post liquefaction absorber is fluidly connected to a liquid outlet of the pre-liquefaction stripper and the liquid outlet of the post-liquefaction absorber is fluidly connected to a liquid inlet of the pre-liquefaction stripper. The pre-liquefaction stripper is arranged with its gas inlet and liquid outlet at a bottom of the pre-liquefaction stripper and with its gas outlet and liquid inlet at a top of the pre-liquefaction stripper.

In some embodiments, the system further comprises a first stripper and the liquid outlet of the low-pressure desorption unit is fluidly connected to the liquid inlet of the first absorber through a liquid inlet and liquid outlet of the first stripper, wherein the first stripper further has a gas inlet fluidly connected to an external gas source, suitably a source of air or nitrogen. In some embodiments, the gas inlet of the first stripper is fluidly connected to the gas outlet of the methane recovery unit, and a gas outlet of the first stripper is fluidly connected to the first absorber, optionally through the biogas feed compressor.

In some embodiments, the system further comprises:
a second absorber having a gas inlet fluidly connected to the gas outlet of the first absorber, a liquid inlet, a gas outlet and a liquid outlet;
a second stripper having a gas inlet, a gas outlet, a liquid inlet and a liquid outlet fluidly connected to the liquid inlet of the second absorber; and
a second methane flash unit, wherein the liquid outlet of the second absorber is fluidly connected to the liquid inlet of the second stripper through a liquid inlet and a liquid outlet of the second methane recovery flash unit, said second flash unit further having a gas outlet fluidly connected to the first absorber, optionally trough the biogas feed compressor. The second flash unit comprises a valve for reducing pressure.

In a development of the previous embodiment, the system further comprises a second methane recovery unit, wherein the liquid outlet of the second absorber is fluidly connected to the liquid inlet of the second methane flash unit through a liquid inlet and liquid outlet of the second methane recovery unit, and the gas outlet of the second flash unit is connected the first absorber through a second intermediate compressor and a gas inlet and a gas outlet of the second methane recovery unit. The second methane recovery unit is arranged with its liquid inlet and gas outlet at a top of the second methane recovery unit, and its liquid outlet and gas inlet at a bottom of the second methane recovery unit. The second methane recovery unit may have a further liquid inlet fluidly connected to the liquid outlet second stripper.

In some embodiments, the gas outlet of the second stripper is fluidly connected to the first absorber and the gas inlet of the second stripper is fluidly connected to the gas outlet of the second absorber.

A second aspect of the invention provides a method for recovering carbon dioxide from a combined biogas upgrading process and carbon dioxide liquefaction process, which method comprises the steps of
a) obtaining a carbon dioxide rich liquefaction feed from the biogas upgrading process, which biogas upgrading process removes carbon dioxide from a biogas feed,
b) liquifying the carbon dioxide-rich feed in the liquefaction process thereby providing a purified carbon dioxide product and a non-condensed portion,
c) contacting the non-condensed portion obtained in step b) with a physical absorbent in a post-liquefaction absorber thereby providing a washed non-condensed portion and a loaded physical absorbent, the washed non-condensed portion having a lower content of carbon dioxide than the non-condensed portion,
d) regenerating the loaded physical absorbent to release carbon dioxide therefrom and recycling the released carbon dioxide into the carbon dioxide rich liquefaction feed obtained from the biogas upgrading process.

In some embodiments, step d) of the method for recovering carbon dioxide, comprises contacting the loaded physical absorbent with the carbon dioxide rich feed in a pre-liquefaction stripper, prior to the liquefaction process in step b), thereby providing the physical absorbent and an enriched liquefaction feed for step b).

In some embodiments step d) of the method for recovering carbon dioxide comprises: sending the loaded physical absorbent to the biogas upgrading process for regeneration in a desorption unit, which desorption unit provides the carbon dioxide rich liquefaction feed.

In some embodiments, the liquefaction process in step b) of the method for recovering carbon dioxide is the preferred liquefaction process previously described, comprising steps l1), l2), and l3).

The method according to the second aspect of the invention may also be used for carbon dioxide-rich liquefaction feeds obtained from other processes than a biogas upgrading process, such as from waste gas carbon dioxide capture processes. The waste gas could for example be a flue gas or an off-gas from a fermentation process, such as a brewing process.

Hence also disclosed herein is a method for increasing carbon dioxide recovery of a carbon dioxide liquefaction process, which method comprises the steps of
a′) obtaining a carbon dioxide rich liquefaction feed,
b′) liquifying the carbon dioxide-rich feed in the liquefaction process thereby providing a purified carbon dioxide product and a non-condensed portion,
c′) contacting the non-condensed portion obtained in step b′) with a liquid absorbent in a post-liquefaction absorber thereby providing a washed non-condensed portion and a loaded liquid absorbent, the washed non-condensed portion having a lower content of carbon dioxide than the non-condensed portion,
d′) regenerating the loaded liquid absorbent to release carbon dioxide therefrom and recycling the released carbon dioxide into the carbon dioxide rich liquefaction feed.

In some embodiments, step d′) of the method for increasing carbon dioxide recovery of a carbon dioxide liquefaction process, comprises contacting the loaded liquid absorbent from step c′) with the carbon dioxide rich feed in a pre-liquefaction stripper, prior to the liquefaction process in step b′), thereby providing the liquid absorbent and an enriched liquefaction feed for step b′).

In some embodiments step a′) of the method for increasing carbon dioxide recovery of a carbon dioxide liquefaction process comprises obtaining the carbon dioxide rich liquefaction feed from an upstream carbon dioxide absorption process, and step d′) comprises: sending the loaded liquid absorbent from step c′) to the upstream carbon dioxide absorption process for regeneration in a desorption unit, which desorption unit provides the carbon dioxide rich liquefaction feed. The upstream carbon dioxide absorption process is a process where carbon dioxide is captured from a gas stream by absorption. The term “upstream” is used to denote that the carbon dioxide absorption process is upstream of the liquefaction process, compared to the post-liquefaction absorber, which is downstream of the liquefaction process. The desorption unit is part of the upstream absorption process and is the unit where carbon dioxide, which has been captured in absorbent, is released to regenerate the absorbent and provide the carbon-dioxide rich liquefaction feed. The gas stream from which carbon dioxide is captured is a waste gas, such as flue gas or a fermentation off-gas. The liquefaction process in step b′) of the method for increasing carbon dioxide recovery of a carbon dioxide liquefaction process may be the preferred liquefaction process previously described, comprising steps l1), l2), and l3).

### DETAILED DESCRIPTION

In the following embodiments of the invention will be described with reference to schematic drawings in which,

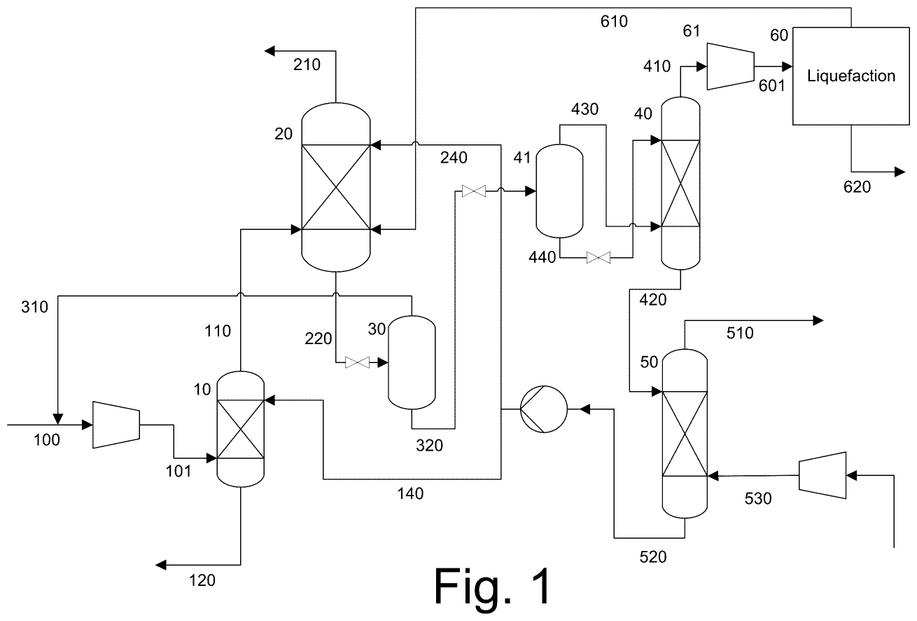

FIG. 1 shows an embodiment where a carbon dioxide liquefaction process is integrated with a biomethane upgrading process having one absorption step, a vacuum desorption step, a first stripping step and a recycle of the non-condensed portion obtained from the liquefaction,

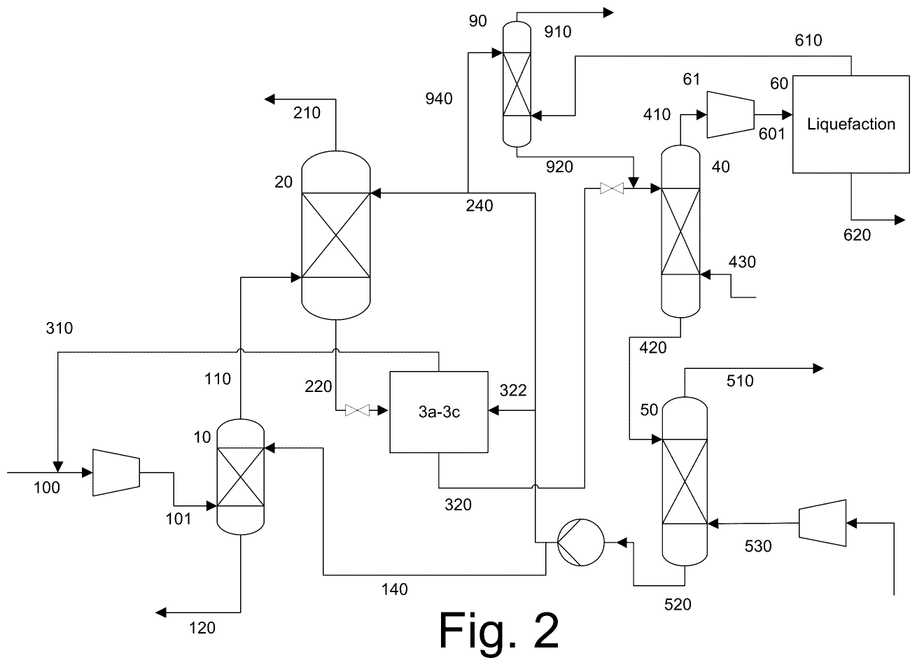

FIG. 2 shows an embodiment like the one in FIG. 1 but with a post-liquefaction absorption step of the non-condensed portion from the liquefaction process,

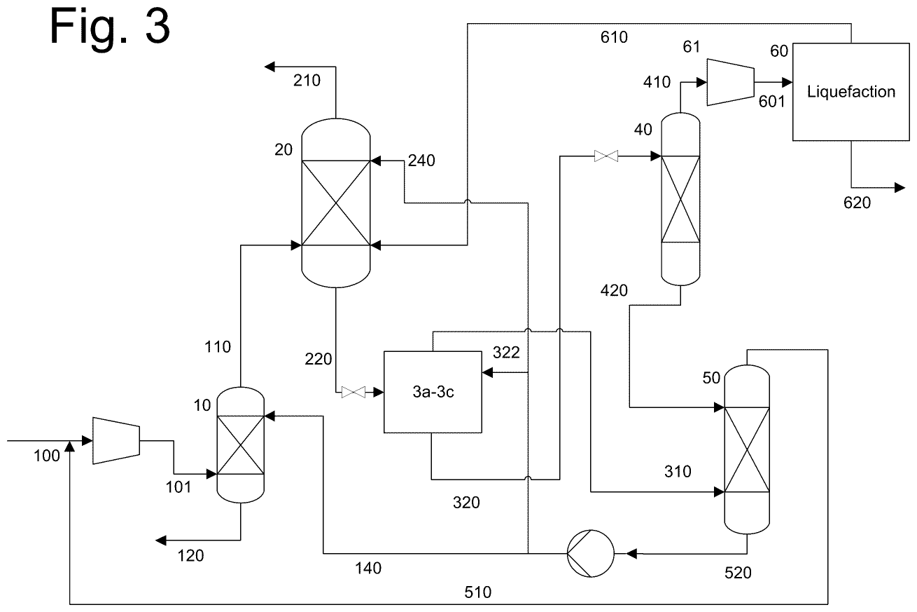

FIG. 3 shows an embodiment like the one in FIG. 1, but wherein the first strip gas in the first stripper is the first recovered methane portion,

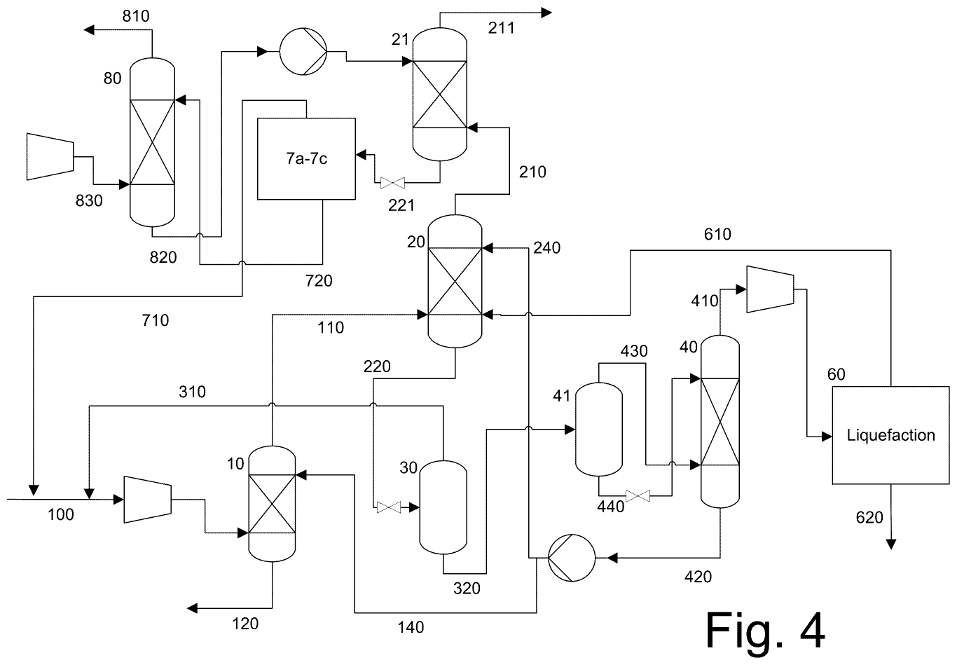

FIGS. 4 to 9 show embodiments where a carbon dioxide liquefaction process is integrated with a biogas upgrading process having two absorption steps,

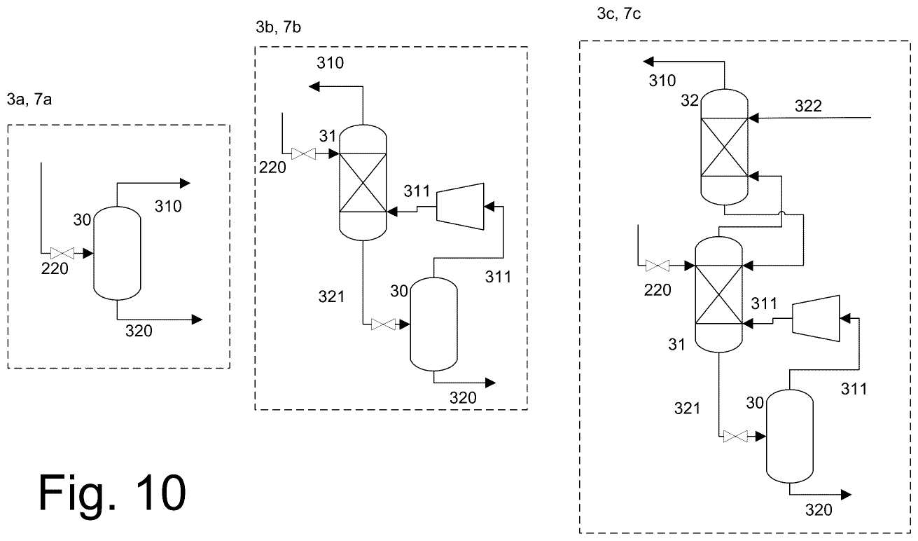

FIG. 10 shows three embodiments of methane recovery steps, and

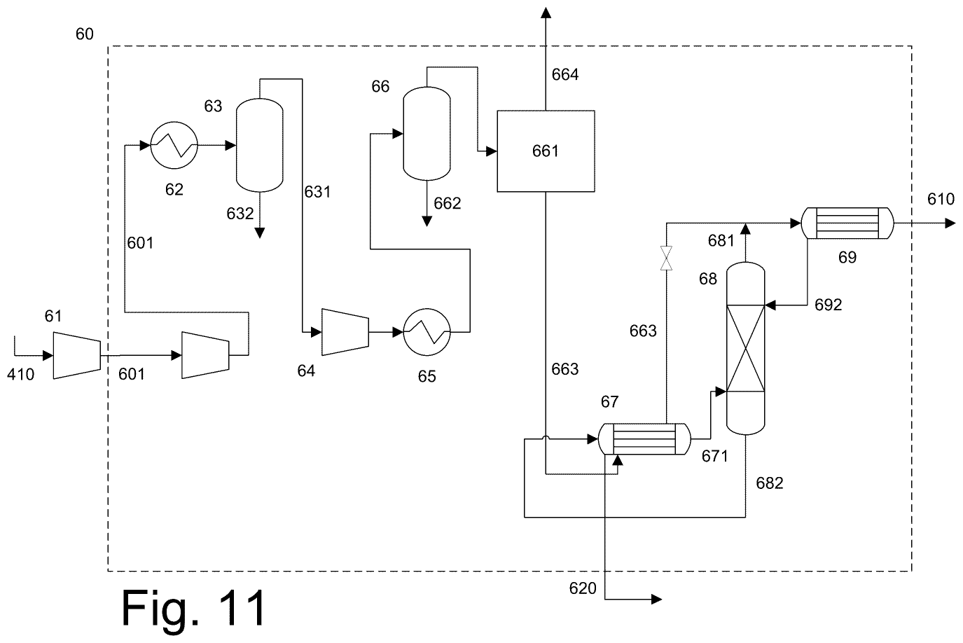

FIG. 11 shows an exemplary carbon dioxide liquefaction process.

All figures are shown in a schematic manner which may not show all units, such as heat-exchangers, chillers, water separation vessels, pumps, valves and compressors.

Referring first to FIG. 1 which shows an embodiment of a biogas upgrading process integrated with a carbon dioxide liquefaction process 60. The biogas upgrading process is what will be referred to as a “single stage” upgrading process as the biogas feed 100 is upgraded to the upgraded biogas 210 in one absorption step, namely in the first absorber 20. Prior to treatment in the first absorber 20, the biogas feed 100 is pre-washed in pre-washer 10 with pre-wash liquid 140 which absorbs volatile organic compounds, such as butanol, providing spent pre-wash liquid 120. The spent-prewash liquid 120 is in this embodiment discarded to remove VOCs from the process. Alternatively, the spent pre-wash liquid can be regenerated for reuse in the process, by heat treatment and optionally also stripping. Removing VOCs by the pre-washer prevents accumulation of nutrient for microbial growth in the process, which otherwise may lead to issues with foaming. The pre-washer operates with a small flow of liquid compared to the gas flow, typically at gas-to-liquid ratio of more than 200% or more than 400% based on moles. The pre-washer will typically operate at the same temperature and pressure as the first absorber. Due to the low liquid flow rate in the pre-washer 10, the amount of carbon dioxide removed from the feed gas in the pre-washer 10 is negligible, and the pre-washer is thus not considered an absorption step in the context of any of the embodiments of the invention.

The washed biogas feed 110 is sent to the first absorber 20 and contacted counter-currently with first absorbent 240 to remove carbon dioxide and provide an enriched biogas 210, which in this embodiment is also the product, the upgraded biogas 210. A loaded first absorbent 220, which is enriched in carbon dioxide, is withdrawn from the bottom of the first absorber 220. To reduce the absorbent circulation, the first absorber operates at elevated pressures, typically at least 5 bar(a), such as in the range 5 to 30 bar(a). Low temperatures also increase solubility of gas and the first absorbent is heated during the absorption, hence the temperature of the first absorber and first absorbent should be kept as low as is practical with the available cooling sources, for example, in the range 5 to 25° C., or 5 to 15° C. The flow of first absorbent 240 in the first absorber 20 is adjusted to achieve the desired target purity of the upgraded biogas 210, in combination with the height of the first absorber. The first absorber 20 may be a packed column or trayed column as commonly used in gas absorption processes. In this embodiment, entrained methane is recovered from the loaded first absorbent 220 in a first absorption step 30, here a flash separation by reducing the pressure of the loaded first absorbent 220. The first recovered methane portion 310 contains both methane and carbon dioxide and is recycled back into the first absorber 20 by adding it upstream thereof, such as to the biogas feed 100, to obtain a combined biogas 101, thereby increasing the methane recovery rate of the process. A methane-lean loaded first absorbent 320 is withdrawn from the flash-separation 30 and subjected to a vacuum desorption step in a low-pressure desorption unit 40. In this embodiment, a strip gas 430 for the low-pressure desorption unit, is provided by flashing the methane-lean loaded first absorbent 320 in flash separator 41 upstream low-pressure desorption unit 40. The liquid 440 withdrawn from flash separator 41 is thus stripped with the strip gas 430 in low-pressure desorption unit 40 at an operating pressure below ambient pressure, which operating pressure is maintained by vacuum pump 61. A carbon dioxide rich intermediate 410 is withdrawn from the top of the low-pressure desorption unit 40 and pressurized to a pressurized carbon dioxide-rich intermediate 601, which is sent to the liquefaction process 60 for further purification and condensation, providing a purified carbon dioxide product 620, i.e. liquefied carbon dioxide. Liquefaction processes are known to the skilled practitioner and a suitable example of a liquefaction is shown in FIG. 11. A non-condensed portion 610 from the liquefaction process 60 is recycled back to the first absorber 20 to recover the methane and carbon dioxide contained non-condensed portion 610.

The liquid withdrawn from the bottom of low-pressure desorption unit 40 is a lean first absorbent 420 which in this embodiment is sent for further regeneration in a first stripper 50 using first strip gas 530. The step removes residual carbon dioxide from the lean first absorbent 420 which is vented from the process in the spent first strip gas 510. The regenerated first absorbent 520 is repressurized and portions thereof are sent to pre-washer 10 and first absorber 20 for re-use as absorbent/wash liquid. A large volume of first strip gas 530, which is typically air, can be used to cost-efficiently remove residual carbon dioxide from the lean first absorbent 420, increasing the capacity of the absorbent and reducing the circulation rate. The operating pressure of the first stripper will typically be about atmospheric.

The majority of carbon dioxide contained in the methane-lean loaded first absorbent 320 is removed in the low-pressure desorption unit 40 and recovered in the carbon dioxide-rich intermediate, while a minor part is removed in the first stripper, providing a high carbon dioxide recovery rate. The carbon dioxide rich intermediate 410 may thus comprise at least 50, 60, 70, 80 or 90% of the carbon dioxide removed from the methane-lean first absorbent 320 in order to obtain the regenerated first absorbent 520.

In FIG. 1 the first methane recovery step 30 is a single flash-separation, but it could have been a series of flash-separations with a sequential reduction in pressure. Further alternative first methane recovery steps 3b and 3c are shown in FIG. 10, which could replace the flash separation 30 in FIG. 2, to increase methane recovery from the loaded first absorbent 220.

The process shown in FIG. 1 achieves high recovery rates of both methane and carbon dioxide both at high purity. Example I and Table I show exemplary performance and operational parameters of a process according to FIG. 1.

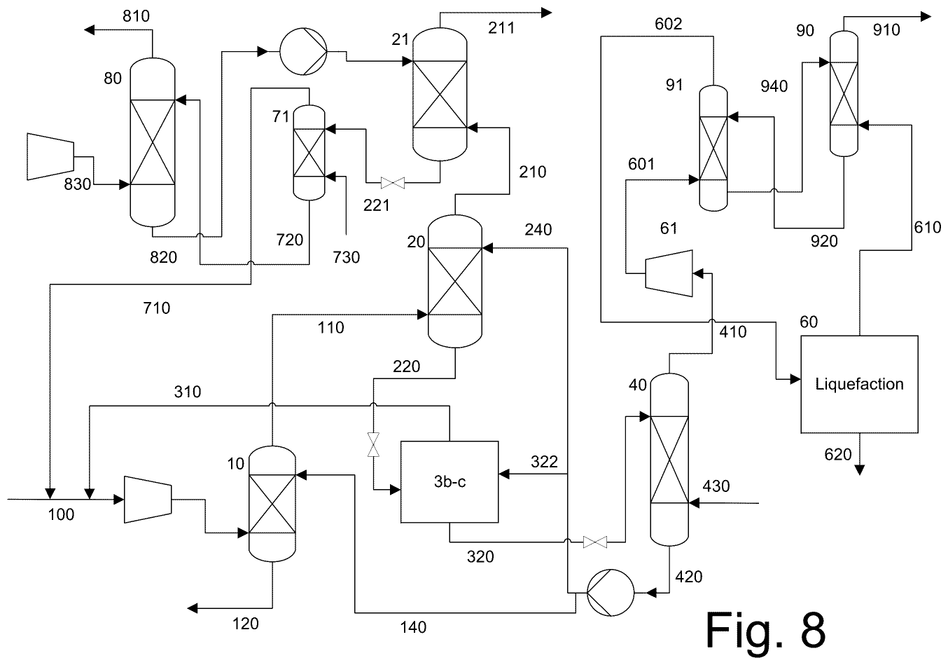

Turning now to embodiment shown in FIG. 2, which is also a single stage biogas upgrading process integrated with a liquefaction process 60, but where a post-liquefaction absorber 90 is used to recover carbon dioxide from the non-condensed portion 610. In FIG. 2 the first methane recovery step 3a-3c is depicted generically, referring to the configurations 3a, 3b and 3c shown in FIG. 10. Intermediate absorbent 322 shown in FIG. 2 is not present when the first methane recovery step is according to configuration 3a and 3b. Compared to FIG. 1, the process of FIG. 2 does not recycle the non-condensed portion 610 into the first absorber 20, but absorbs carbon dioxide into a third absorbent 940 which is obtained from the low-pressure desorption unit 40 as a portion of the regenerated first absorbent 520. A loaded third absorbent 920, which contains absorbed carbon dioxide, is then sent to the low-pressure desorption unit 40, where carbon dioxide is released into the carbon dioxide-rich intermediate 410. This configuration is especially suitable for biomethane upgrading processes wherein the first methane recovery step provides a high recovery rate of methane, such as the configurations shown in variations 3b and 3c in FIG. 10, which is described in greater detail below in connection with FIG. 10. Using the post-liquefaction absorber 90 also allows for using an “external” strip gas 430, which in the embodiment shown is air, since external gas is not recycled into the biogas upgrading process, for example, to the first absorber 20. In this way, the carbon dioxide recovery rate of the process can be increased without contaminating the upgraded biogas 210. The post-liquefaction absorber 90 also advantageously integrates with the biogas upgrading process as the existing units for regenerating the first absorbent can also regenerate the third absorbent. As alternative to regenerating the loaded third absorbent 920 in the low-pressure desorption unit 40, a further stripping column can be provided, where the third absorbent is regenerated by stripping it with the carbon dioxide-rich intermediate 410 downstream of the low-pressure desorption unit 40. An example using such a pre-liquefaction stripper is shown in FIG. 8 in a so called two-stage absorption process.

Example II and Table II shows exemplary performance and operational parameters of a process according to FIG. 2.

Referring now to FIG. 3 showing a further embodiment with single-stage absorption. In this embodiment, the first strip gas used in the first stripper 50 to remove residual carbon dioxide is the first recovered methane portion 310 and the spent first strip gas 510 is recycled to the first absorber 20 to recover methane and carbon dioxide. In this way the residual carbon dioxide in the lean first absorbent 420 is not lost. In FIG. 13 the non-condensed portion 610 is recycled back into the first absorber 20 to recover methane. Depending on the methane recovery achieved in the first methane recovery steps 3a-3c, the non-condensed portion 610 can be treated in a post-liquefaction absorber as previously described.

Example III and Table III shows exemplary performance and operational parameters of a process according to FIG. 3.

Referring now to FIG. 4 showing an embodiment where the biogas upgrading process is a “two-stage” process where carbon dioxide is removed from the biogas feed 100 in the first absorber 20 and a second absorber 21 to provide the upgraded biogas 211. The gas obtained from the first absorber 20 is called an enriched biogas 210 to distinguish it from the product gas, which is the upgraded biogas 211. The two absorbers 20, 21 are here shown as two separate units, but they can equally be two sections of the same unit, where loaded second absorbent is withdrawn from a point between the two sections. The two-stage absorption processes have two absorbent loops, one loop where the first absorbent 240 is fed to the first absorber 20, the loaded first absorbent 220 is withdrawn from the first absorber and then regenerated in the low-pressure desorption unit 40 to provide the carbon dioxide-rich intermediate 410 and the lean first absorbent 420 which is recycled back to the first absorber 20. The second absorbent loop is the second absorbent 820 being fed to second absorber 21 and regenerated in a second stripper 80. In this embodiment there is no exchange between the two absorbent loops. The first and second absorbents 240, 820 are both physical absorbents and are preferably the same, for example, both the first and second absorbent can be water. The first absorbent loop is similar to that of FIG. 1 apart from not having the first stripper 50 (see FIG. 1), and the first absorbent 240 and pre-wash 140 are obtained directly from the lean first absorbent 420 as portions thereof. The second absorbent loop comprises the second absorber 21, the second methane recover step 7a-7c, and the second stripper 80. The second methane recovery step 7a-7c may have the configurations 7a-7c shown in FIG. 10, which are the same as the first methane recovery steps 3a-3c, apart from the ingoing and outgoing flows connecting to the second absorbent loop. Hence, the intermediate absorbent (not shown in FIG. 4, but indicated in FIG. 10 by reference 322) in configuration 7c is referred to as the second intermediate absorbent and is a portion of a regenerated second absorbent 820. The second recovered methane portion 710 is recycled back to the first absorber 20 to increase methane recovery. The methane-lean second absorbent 720 is regenerated in the second stripper 80 by second strip gas 830, typically air, providing spent second strip gas 810 and regenerated second absorbent 820.

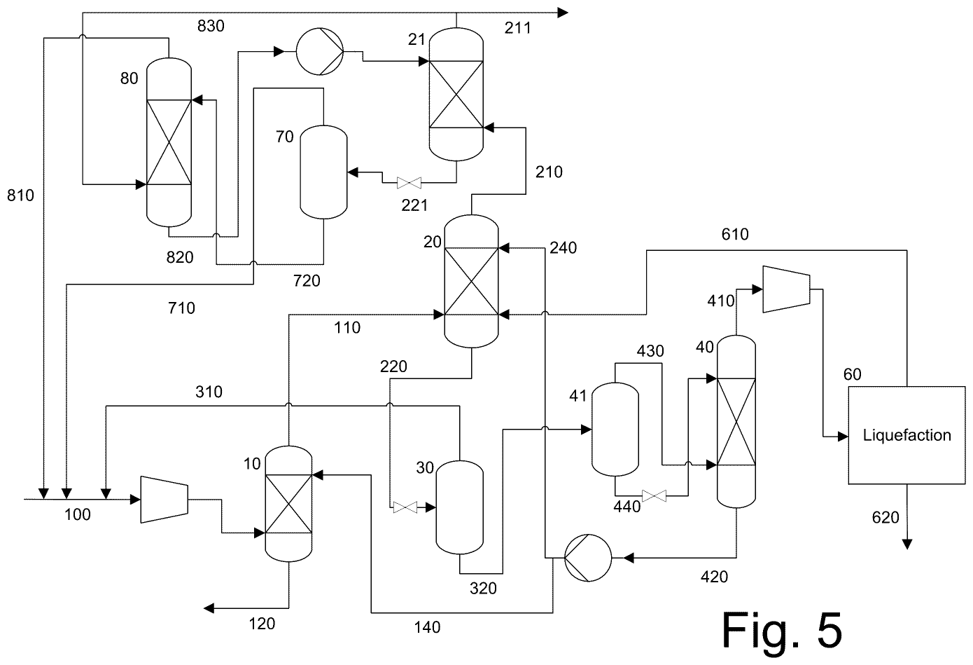

Referring now to FIG. 5, showing a further embodiment with a two-stage biogas upgrading process. The process is similar to that of FIG. 4, but the second methane recovery step is according to configuration 7a shown in FIG. 10, i.e. a flash-separation 70, and the second strip gas 830 is a portion of the upgraded biogas 211. The upgraded biogas 211, having high purity of methane, can efficiently strip carbon dioxide from the methane-lean absorbent 720 and the resulting spent second strip gas 810 containing mainly methane and carbon dioxide is recycled to recover both methane and carbon dioxide. In this way, carbon dioxide removed in the second absorber 21 is recovered in the carbon dioxide-rich intermediate 420 to increase carbon dioxide recovery.

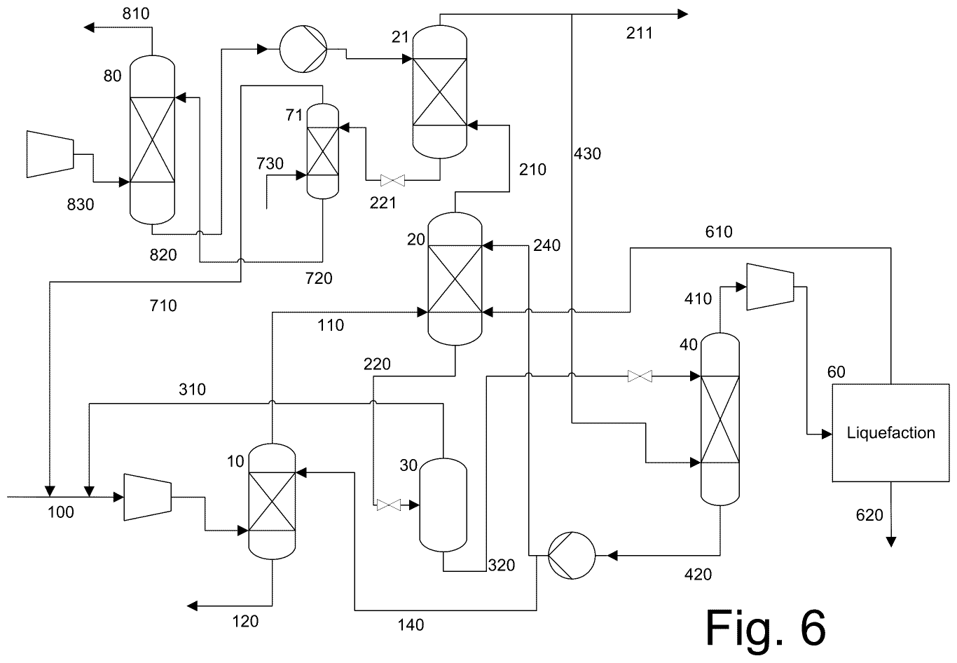

Referring now to FIG. 6 which shows another two-stage process where a portion of the upgraded biogas 211 is used as the strip gas 430 in the low-pressure desorption unit 40 to increase carbon dioxide recovery. The methane from the strip gas 430 is recovered by recycling the non-condensed portion 610 obtained from the liquefaction process 60. The upgraded biogas could be used as strip gas in a single-stage absorption process in the same way. The second methane recovery step is here a stripping of the loaded second absorbent 221 with a small amount of external gas 730, here nitrogen.

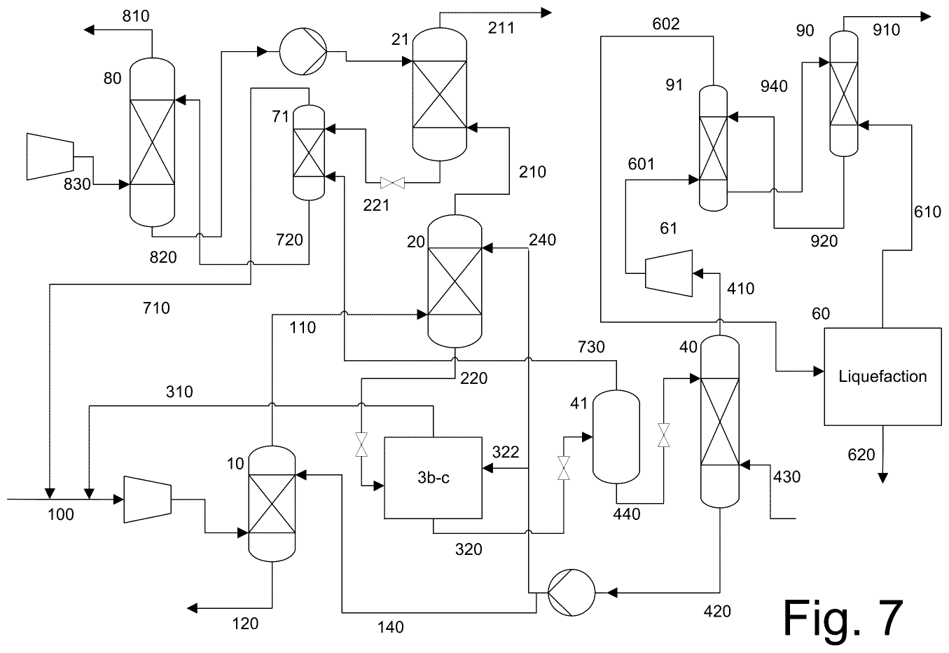

Referring now to FIG. 7 which shows a further embodiment with a two-stage absorption process. In this embodiment the loaded second absorbent 221 is stripped with a gas 730 obtained by flashing the methane-lean first absorbent 320. As in FIG. 2, a post-liquefaction absorber 90 is used to recover carbon dioxide from the non-condensed portion 610, which also allows the use of an external strip gas 430 in the low-pressure desorption unit 40, such as air. As there is no recycle of the non-condensed portion into the biogas process, the first methane recovery step is advantageously configured as configurations 3b or 3c in FIG. 10. The loaded third absorbent 920 is in this embodiment regenerated in a pre-liquefaction stripper 91, where the carbon dioxide-rich intermediate is contacted with the loaded third absorbent 920 providing the third absorbent 940 and an enriched liquefaction feed 602 which contains more carbon dioxide compared to the carbon dioxide rich intermediate 601.

FIG. 8 shows a process similar to FIG. 7, but wherein an external gas 730 is used in the second methane recovery step 71 to strip methane from the loaded second absorbent. Example V and Table V show exemplary performance and operational parameters of a process according to FIG. 8.

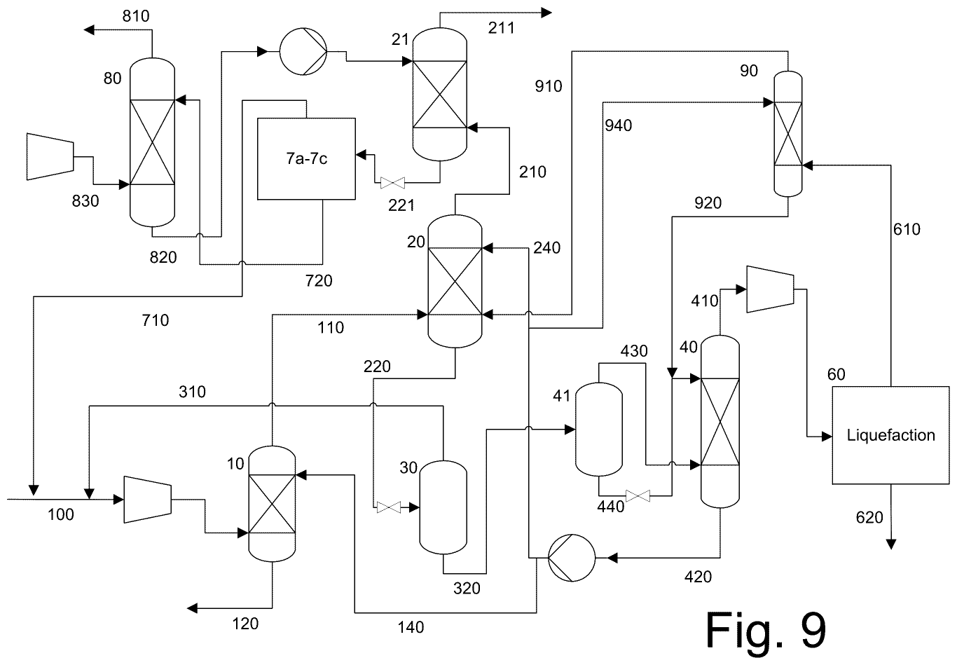

FIG. 9 shows another embodiment with a two-stage biogas process where the liquefaction process 60 has a post-liquefaction absorber 90, and the loaded third absorbent is regenerated in the low-pressure desorption unit 40. The first methane recovery step 30 is a simple flash, and hence the washed non-condensed portion 910 is recycle to the first absorber. In a further variant of FIG. 9, the methane-lean second absorbent 720 is flashed upstream of the second stripper 80 and the gas thus obtained is recycled to the carbon dioxide-rich intermediate 410, for example, into the low-pressure desorption unit 40, to increase the carbon dioxide recovery of the process.

Example IV and Table IV shows exemplary performance and operational parameters of a process according to FIG. 9.

Referring now to FIG. 10 which shows three configurations 3a, 7a; 3b, 7b and 3c, 7c of methane recovery steps, which may be used as the first methane recovery step and the second methane recovery step, respectively. The processes of FIG. 10 are depicted as examples of first methane recovery steps where the inlet liquid is the loaded first absorbent 220, the outlet liquid is the methane-lean first absorbent 320 and the outlet gas is the first recovered methane portion 310. When used as the second methane recovery steps 7a-7c, the corresponding flows would be the loaded second absorbent 221, methane-lean loaded 720 second absorbent and second recovered methane portion 710. Configuration 3a, 7a is simple flash separation achieved by pressure reduction and gas/liquid separation in vessel 30. In some embodiments of methane recovery steps, several flash separations at successively lower pressures may be used, the resulting gas portions combining to form the recovered methane portion.

Configuration 3b, 7b is a flash of the loaded first absorbent 220 into a methane recovery unit 31 where the resulting liquid is contacted with an intermediate recovered gas 311 to remove further methane from the liquid into the first recovered methane portion 310. The intermediate recovered gas 311 is obtained by flashing an intermediate methane-lean first absorbent 321 withdrawn from the methane recovery unit 31 and pressurizing to the operation pressure of the methane recovery unit 31.

Configuration 3c, 7c is a further development of configuration 3b, 7b, where fresh absorbent, here intermediate absorbent 322, is contacted with the gas of methane recovery unit 31 to remove carbon dioxide. In FIG. 10 this is shown as a further separate methane recovery unit 32, but the methane recovery units 31 and 32 could equally be two sections of the same unit, where the first absorbent 320 is fed in between the sections.

Using a first methane recovery step configured as in 3a will reduce the methane content of the loaded first absorbent 220, but leaves a residual amount methane in the liquid, and at least part of said residual amount will be present in the carbon dioxide rich intermediate 410. The residual amount of methane will generally be large enough for it to be beneficial to recycle the non-condensed portion 610 obtained back into the biogas upgrading process to recover it.

Using a first methane recovery step configured as in 3b or 3c improves the methane recovery in the first methane recovery step, whereby the methane content in the carbon dioxide-rich intermediate 410 is low enough to provide a high overall methane recovery rate without recycling the non-condensed portion 610. This then allows for the use of alternative ways of recovering carbon dioxide from the non-condensed portion, such as the post-liquefaction absorber, in combination with allowing the use of external strip gasses 430 in the low-pressure desorption column.

Referring now to FIG. 11 which shows an example of a liquefaction process 60 suitable for liquefying carbon dioxide. This embodiment includes distillation in units 67 and 68 and thus provides a high purity carbon dioxide product 620. The carbon dioxide-rich intermediate 410 is received from a biogas upgrading process, which uses for example water as the absorbent, here through vacuum pump 61 which is used to maintain the operating pressure of the low-pressure desorption unit (not shown). In the first part of the liquefaction process the carbon dioxide rich intermediate 410 is pressurized in one or more compressor stages to provide the pressurized carbon dioxide-rich intermediate and then cooled in chiller 62 before separating condensed water 632 out in separation vessel 63. This first separation may be at 3.3 bar(a) and about 35° C. The remaining gas 631 is further pressurized in one or more compressor stages 64 and cooled in chiller 65 to condense further water which is removed as condensed water 662 in separation vessel 66. Subsequently other impurities, for example, hydrogen sulphide and/or VOC are removed in purification step 661. Purification step 661 can be any process known in the art to remove the impurities, such as a biofilter, an activated carbon filter, or selective absorption. The impurities are removed from the process in stream 664. The purification step 661 may in other be placed elsewhere in the liquefaction process, for example upstream of separation vessel 63 (not shown). At this stage the gas 663 may be a pressure of about 20 bar(a) and 25° C. The gas 663 is sent to reboiler 67 associated with stripper (distillation column) 68. In reboiler 67, the temperature of the gas 663 is reduced to about −23° C. before being sent to condenser 69 for condensation. The condenser 69 provides condensed portion 692 and a non-condensed portion 610. The temperature and pressure of the condenser 69 is typically selected according to the cooling source which is available. If cooling water at for example 0 to 10° C., is available then condensation at high pressures, such as above 40 bar(a), is chosen. If refrigeration is used to achieve lower temperatures, such as in the range of −50 to −20° C., then the pressure in the condenser can also be lowered. Depending on the methane content of the carbon-dioxide-rich intermediate 410, the condensed portion 692 may contain a minor portion of methane or other contaminants. Hence, the condensed portion 692 is sent to stripper 68 where methane is released by stripping with gas 671, the recovered methane is withdrawn from the top of stripper 68 as gas 681 which is then sent to condenser 69. The liquid obtained from the bottom of stripper 68 is purified carbon dioxide, typically with a purity above 99 mol % carbon dioxide, even above 99.9 mol %. In this embodiment, the liquid 682 is sent to reboiler 67 to cool gas 663, whereby a portion of liquid 682 evaporates providing the stripping gas 671 for the stripper 68, and the remaining portion of liquid 682 is withdrawn as the purified carbon dioxide 620 from reboiler 67, for example at about −24° C. at about 17 bar(a). The non-condensed portion 610 obtained from condenser 69 contains carbon dioxide corresponding to the vapor-liquid equilibrium of the condenser 69 and possibly also contains methane depending on the methane content of the carbon dioxide-rich intermediate 410. The non-condensed portion 610 can also contain nitrogen or air, if these are used as stripping gas to provide the carbon dioxide rich intermediate 410. If the methane content of the carbon dioxide rich intermediate 410 is low or substantially zero, which as previously described can be achieved by removing methane in the first recovery step configured as shown in 3b or 3c in FIG. 10, then the non-condensed portion 610 can advantageously be treated in the post-liquefaction absorber as previously shown in FIGS. 2, 7 and 8, to recover the carbon dioxide left in the non-condensed portion 610. If on the other hand, the carbon dioxide-rich intermediate 410 contains methane, for example if there is no first methane recovery step, or the methane recovery of the first methane recovery step is low, the non-condensed portion 610 may advantageously be recirculated to the first absorber of the biogas upgrading process as in FIGS. 1, and 3 to 6, or 9 to recover both methane and carbon dioxide. The temperatures and pressures mentioned in above in relation to FIG. 11 are exemplary, and other temperatures and pressures can be used as is known to the skilled practitioner.

FIG. 11 shows a carbon dioxide liquefaction process where stripper 69 and reboiler 67 is used to provide a carbon dioxide product with high purity or even pure carbon dioxide. In cases where high carbon dioxide product purity is not needed, for example if the carbon dioxide is to be used in carbon dioxide sequestration, then the stripper 69 and reboiler 67 can be omitted.

### EXAMPLES

The advantages of the invention are illustrated below by way of the below non-limiting examples. The examples are computer simulations of processes according to the invention performed in a commercially available process simulator, such as CHEMCAD®. In all of the examples the absorbent is water.

### Example I

This example reports the performance of a process according to FIG. 1 with a liquefaction process as shown in FIG. 11. The performance is evaluated based on the methane purity of the upgraded biogas, the methane recovery rate, the carbon dioxide recovery rate and the total power use.

The methane purity is the percentage of methane in the upgraded biogas.

The recovery rate of methane is the amount of methane in the upgraded biogas as a percentage of the amount of methane in the biogas feed.

The recovery rate of carbon dioxide is the amount of carbon dioxide in the purified carbon dioxide product as a percentage of the amount of carbon dioxide in the biogas feed.

The total power use is the sum of the duties for the
Compressor for pressurizing biogas prior to the first absorber
Pump for circulating first lean absorbent
Pump for circulating regenerated first absorbent
Vacuum pump for low-pressure desorption unit
Compressors in the liquefaction process
Chillers for feed biogas (upstream of pre-washer)
Chiller for first absorbent
Chillers and condenser in the liquefaction process

The results are reported in Table I.

The process shows a methane purity 98.3 mol % a methane recovery rate of 99.81%, a carbon dioxide recovery rate of 87% at a power usage of 350.56 W/Nm3 biogas.

In addition, the biogas feed contains small amounts of species used as proxies for VOC's which may be found in biogas. These species and the amounts are not shown in Table I. The biogas feed contains 0.023 kmol/h of each of acetone, N-butanol, D-limonene, and butanone. These species are absorbed in the physical absorbent (water), and acetone, N-butanol and butanone are water soluble species which will not, or only to a small degree, be removed from the loaded absorbent in the desorption and stripping steps. D-limonene is a terpene and is insoluble in water, hence D-limonene is removed from the loaded absorbent in the desorption and stripping steps.

In the present example, the spent pre-wash contains 96% of the acetone, 74% of the N-butanol, 0% of the D-limonene, and 91% of the butanone contained in the biogas feed. Hence, the water-soluble species are washed from the process in the pre-washer, which prevents accumulation in the physical absorbent, which could otherwise lead to issues with microbial growth and/or foaming as previously described.

The VOC proxies are also present and removed in the pre-washer in Examples II-V, but the details are not reported.

### Example II

This example reports the performance of a process according to FIG. 2, wherein the first methane recovery step is configuration 3c as shown in FIG. 10, and the liquefaction process is as shown in FIG. 11.

The performance is evaluated according to the same parameters as described in example I, but the power usage further includes
compressor duty for intermediate recovered gas 311
pump duty for intermediate absorbent 322
compressor duty for first strip gas 530
pump duty for third absorbent 940

The methane recovery units 31 and 32 were operated at 3 bar(a) and the flash separation 30 at 1.45 bar(a), referring to configuration 3c in FIG. 10.

The results are reported in Table II.

The process shows a methane purity 98.3 mol % a methane recovery rate of 99.96%, a carbon dioxide recovery rate of 91.6% at a power usage of 375.56 W/Nm3 biogas.

### Example III

This example reports the performance of a process according to FIG. 3, wherein the first methane recovery step is configuration 3c as shown in FIG. 10, and the liquefaction process is as shown in FIG. 11.

The performance is evaluated according to the same parameters as described in example II, excluding the pump duties for third absorbent and lean first absorbent which is not present. The methane recovery units 31 and 32 were operated at 4.5 bar(a) and the flash separation 30 at 1.9 bar(a), referring to configuration 3c in FIG. 10.

The results are reported in Table III.

The process shows a methane purity 98.4 mol % a methane recovery rate of 99.99%, a carbon dioxide recovery rate of 97.6% at a power usage of 368.02 W/Nm3 biogas.

### Example IV

This example reports the performance of a process according to FIG. 9, wherein the second methane recovery step is configuration 7b as shown in FIG. 10, and the liquefaction process is as shown in FIG. 11.

The performance is evaluated according to the same parameters as described in example I, but the power usage further includes
compressor duty for intermediate recovered gas in second methane recovery step 7b
pump duty for intermediate absorbent in the second methane recovery step 7b
compressor duty for second strip gas 530
pump duty for third absorbent 940
chiller duty for the second absorbent 820,
compressor duty for the second absorbent 820

The methane recovery units 31 were operated at 1,015 bar(a) and the flash separation 30 at 0.2 bar(a), referring to configuration 7b in FIG. 11.

The results are reported in table IV.

The process shows a methane purity 98.6 mol % a methane recovery rate of 99.99%, a carbon dioxide recovery rate of 92.1% at a power usage of 359.50 W/Nm3 biogas.

### Example V

This example reports the performance of a process according to FIG. 8, wherein the first methane recovery step 3b is configured as shown in FIG. 11.

The performance is evaluated according to the same parameters as described in example IV, but the power usage further includes
compressor duty for intermediate recovered gas in first methane recovery step 3b
pump duty for intermediate absorbent in the first methane recovery step 3b
compressor duty for second strip gas 530
pump duty for third absorbent 940
chiller duty for the second absorbent 820,
compressor duty for the second absorbent 820

The methane recovery unit 31 were operated at 3.5 bar(a) and the flash separation 30 at 1.65 bar(a), referring to configuration 3b in FIG. 11.

The results are reported in table V.

The process shows a methane purity 97.9 mol % a methane recovery rate of 99.70%, a carbon dioxide recovery rate of 90.4% at a power usage of 391.35 W/Nm3 biogas.

TABLE I

| | | T | P | Total | Total | CH4 | H2S | CO2 | H2O | N2 | O2 |
|---|---|---|---|---|---|---|---|---|---|---|---|
| Name | Reference | [° C.] | [bar(a)] | [kg/h] | [kmol/h] | [mol %] | [mol %] | [mol %] | [mol %] | [mol %] | [mol %] |
| Biogas feed | 100 | 35 | 1.013 | 1185 | 46.63 | 61.35 | 0.05 | 33.03 | 5.55 | 0.00 | 0.00 |
| Combined feed | 101 | 10 | 7 | 1174 | 45.65 | 64.27 | 0.05 | 34.46 | 1.20 | 0.00 | 0.00 |
| Washed biogas | 110 | 10 | 6.9 | 1165 | 45.15 | 64.97 | 0.05 | 34.79 | 0.18 | 0.00 | 0.00 |
| Spent pre-wash | 120 | 10 | 6.9 | 189 | 10.47 | 0.02 | 0.00 | 0.21 | 99.72 | 0.00 | 0.00 |
| Upgraded biogas | 210 | 10 | 6.8 | 475 | 29.05 | 98.28 | 0.00 | 0.76 | 0.18 | 0.51 | 0.27 |
| Loaded first absorbent | 220 | 10 | 6.8 | 225776 | 12508.35 | 0.02 | 0.00 | 0.14 | 99.85 | 0.00 | 0.00 |
| First recovered methane | 310 | 10 | 5 | 26 | 1.07 | 68.76 | 0.02 | 30.97 | 0.25 | 0.00 | 0.00 |
| Methane lean loaded first | 320 | 10 | 5 | 225750 | 12507.28 | 0.01 | 0.00 | 0.13 | 99.86 | 0.00 | 0.00 |
| absorbent | | | | | | | | | | | |
| Strip gas | 430 | 10 | 2.6 | 68 | 2.17 | 44.19 | 0.03 | 55.30 | 0.48 | 0.00 | 0.00 |
| Liquid feed to vacuum | 440 | 10 | 2.6 | 225681 | 12505.11 | 0.00 | 0.00 | 0.12 | 99.87 | 0.00 | 0.00 |
| desorber | | | | | | | | | | | |
| Lean first absorbent | 420 | 10 | 0.3 | 225060 | 12490.30 | 0.00 | 0.00 | 0.01 | 99.99 | 0.00 | 0.00 |
| CO2-rich intermediate | 430 | 10 | 0.3 | 690 | 16.98 | 8.17 | 0.10 | 87.57 | 4.14 | 0.00 | 0.00 |
| Spent first strip gas | 510 | 10 | 1.015 | 1080 | 36.70 | 0.14 | 0.02 | 4.79 | 1.23 | 74.21 | 19.62 |
| Regenerated first absorbent | 520 | 10 | 1.015 | 224980 | 12488.26 | 0.00 | 0.00 | 0.00 | 100.00 | 0.00 | 0.00 |
| First strip gas | 530 | 20 | 2 | 1000 | 34.66 | 0.00 | 0.00 | 0.00 | 0.00 | 79.00 | 21.00 |
| Pre wash | 140 | 10 | 8 | 180 | 9.98 | 0.00 | 0.00 | 0.00 | 100.00 | 0.00 | 0.00 |
| First absorbent | 240 | 10 | 8 | 225000 | 12489.39 | 0.00 | 0.00 | 0.00 | 100.00 | 0.00 | 0.00 |
| Pressurized CO2 | 601 | 281 | 3.3 | 690 | 16.98 | 8.17 | 0.10 | 87.57 | 4.14 | 0.00 | 0.00 |
| intermediate | | | | | | | | | | | |
| Non-condensed portion | 610 | −45 | 17 | 87 | 2.86 | 48.54 | 0.00 | 51.46 | 0.00 | 0.00 | 0.00 |
| Purified CO2 | 620 | −25 | 17 | 590 | 13.40 | 0.00 | 0.00 | 100.00 | 0.00 | 0.00 | 0.00 |

| | |
|---|---|
| Methane Purity [mol %] | 98.28 |
| Methane production [kg/h] | 458.01 |
| Methane recovery [%] | 99.81 |
| CO2 production [kg/h] | 589.84 |
| CO2 recovery [%] | 87.02 |
| Total Power [kWh] | 366.34 |
| Total power [W/Nm3 biogas] | 350.56 |
| Biogas power [W/Nm3 biogas] | 225.00 |
| CO2 Power [kW/ton CO2] | 222.46 |

TABLE II

| | | T | P | Total | Total | CH4 | H2S | CO2 | H2O | N2 | O2 |
|---|---|---|---|---|---|---|---|---|---|---|---|
| Name | Reference | [° C.] | [bar(a)] | [kg/h] | [kmol/h] | [mol %] | [mol %] | [mol %] | [mol %] | [mol %] | [mol %] |
| pBiogas feed | 100 | 35 | 1.013 | 1185 | 46.63 | 61.35 | 0.05 | 33.03 | 5.55 | 0.00 | 0.00 |
| Combined feed | 101 | 10 | 7 | 1276 | 48.86 | 62.94 | 0.05 | 35.82 | 1.17 | 0.00 | 0.00 |
| Washed biogas | 110 | 10 | 6.9 | 1265 | 48.34 | 63.61 | 0.05 | 36.15 | 0.18 | 0.00 | 0.00 |
| Spent pre-wash | 120 | 10 | 6.9 | 189 | 10.46 | 0.01 | 0.00 | 0.22 | 99.71 | 0.00 | 0.00 |
| Upgraded biogas | 210 | 10 | 6.8 | 476 | 29.10 | 98.26 | 0.00 | 0.78 | 0.18 | 0.51 | 0.27 |
| Loaded first absorbent | 220 | 10 | 6.8 | 225789 | 12508.61 | 0.02 | 0.00 | 0.14 | 99.84 | 0.00 | 0.00 |
| First recovered methane | 310 | 10 | 3 | 127 | 4.27 | 50.37 | 0.03 | 49.17 | 0.42 | 0.00 | 0.00 |
| Methane lean loaded first | 320 | 10 | 1.45 | 225663 | 12504.40 | 0.00 | 0.00 | 0.12 | 99.88 | 0.00 | 0.00 |
| absorbent | | | | | | | | | | | |
| Strip gas | 430 | 25 | 1 | 25 | 0.87 | 0.00 | 0.00 | 0.00 | 0.00 | 79.00 | 21.00 |
| Liquid feed to vacuum | — | 10 | 0.3 | 230741 | 12783.74 | 0.00 | 0.00 | 0.13 | 99.87 | 0.00 | 0.00 |
| desorber | | | | | | | | | | | |
| Lean first absorbent | 420 | 10 | 0.3 | 230029 | 12767.12 | 0.00 | 0.00 | 0.01 | 99.99 | 0.00 | 0.00 |
| CO2-rich intermediate | 430 | 10 | 0.3 | 737 | 17.49 | 0.06 | 0.10 | 90.70 | 4.15 | 3.92 | 1.05 |
| Spent first strip gas | 510 | 10 | 1.015 | 1049 | 35.97 | 0.00 | 0.02 | 2.92 | 1.23 | 75.78 | 20.05 |
| Regenerated first absorbent | 520 | 10 | 1.015 | 229980 | 12765.81 | 0.00 | 0.00 | 0.00 | 100.00 | 0.00 | 0.00 |
| First strip gas | 530 | 25 | 1.05 | 1000 | 34.66 | 0.00 | 0.00 | 0.00 | 0.00 | 79.00 | 21.00 |
| Pre wash | 140 | 10 | 8 | 179 | 9.95 | 0.00 | 0.00 | 0.00 | 100.00 | 0.00 | 0.00 |
| First absorbent | 240 | 10 | 8 | 225000 | 12489.36 | 0.00 | 0.00 | 0.00 | 100.00 | 0.00 | 0.00 |
| Pressurized CO2 | 601 | 286 | 3.3 | 737 | 17.49 | 0.06 | 0.10 | 90.70 | 4.15 | 3.92 | 1.05 |
| intermediate | | | | | | | | | | | |
| Non-condensed portion | 610 | −38 | 17 | 103 | 2.64 | 0.40 | 0.00 | 66.69 | 0.00 | 25.97 | 6.94 |
| Purified CO2 | 620 | −25 | 17 | 620 | 14.10 | 0.00 | 0.00 | 100.00 | 0.00 | 0.00 | 0.00 |
| washed non-condensed | 910 | 10 | 17 | 24 | 0.84 | 1.13 | 0.00 | 0.00 | 0.07 | 78.69 | 20.10 |
| loaded third absorbent | 920 | 11 | 17 | 5079 | 279.35 | 0.00 | 0.00 | 0.63 | 99.35 | 0.01 | 0.01 |
| Third absorbent | 940 | 10 | 1.015 | 5000 | 277.54 | 0.00 | 0.00 | 0.00 | 100.00 | 0.00 | 0.00 |

| | |
|---|---|
| Methane Purity [mol %] | 98.26 |
| Methane production [kg/h] | 458.69 |
| Methane recovery [%] | 99.96 |
| CO2 production [kg/h] | 620.51 |
| CO2 recovery [%] | 91.55 |
| Total Power [kWh] | 392.61 |
| Total power [W/Nm3 biogas] | 375.70 |
| Biogas power [W/Nm3 biogas] | 245.72 |
| CO2 Power [kW/ton CO2] | 218.90 |

TABLE III

| | | T | P | Total | Total | CH4 | H2S | CO2 | H2O | N2 | O2 |
|---|---|---|---|---|---|---|---|---|---|---|---|
| Name | Reference | [° C.] | [bar(a)] | [kg/h] | [kmol/h] | [mol %] | [mol %] | [mol %] | [mol %] | [mol %] | [mol %] |
| Biogas feed | 100 | 35 | 1.013 | 1185 | 46.63 | 61.35 | 0.05 | 33.03 | 5.55 | 0.00 | 0.00 |
| Combined feed | 101 | 10 | 7 | 1358 | 51.85 | 61.57 | 0.06 | 36.01 | 2.34 | 0.00 | 0.00 |
| Washed biogas | 110 | 10 | 6.9 | 1336 | 50.70 | 62.97 | 0.06 | 36.78 | 0.18 | 0.00 | 0.00 |
| Spent pre-wash | 120 | 10 | 6.9 | 205 | 11.33 | 0.01 | 0.00 | 0.22 | 99.71 | 0.00 | 0.00 |
| Upgraded biogas | 210 | 10 | 6.8 | 503 | 30.59 | 98.37 | 0.00 | 1.44 | 0.18 | 0.00 | 0.00 |
| Loaded first absorbent | 220 | 10 | 6.8 | 225849 | 12509.52 | 0.02 | 0.00 | 0.15 | 99.83 | 0.00 | 0.00 |
| First recovered methane | 310 | 10 | 4.5 | 37 | 2.08 | 93.96 | 0.00 | 5.76 | 0.28 | 0.00 | 0.00 |
| Methane lean loaded first | 320 | 10 | 1.9 | 255813 | 14172.64 | 0.00 | 0.00 | 0.13 | 99.87 | 0.00 | 0.00 |
| absorbent | | | | | | | | | | | |
| Liquid feed to vacuum | — | 10 | 0.6 | 255813 | 14172.64 | 0.00 | 0.00 | 0.13 | 99.87 | 0.00 | 0.00 |
| desorber | | | | | | | | | | | |
| Lean first absorbent | 420 | 10 | 0.3 | 255125 | 14156.51 | 0.00 | 0.00 | 0.02 | 99.97 | 0.00 | 0.00 |
| CO2-rich intermediate | 430 | 10 | 0.3 | 688 | 16.13 | 1.01 | 0.14 | 94.68 | 4.15 | 0.00 | 0.00 |
| Spent first strip gas | 510 | 10 | 0.3 | 203 | 6.89 | 48.22 | 0.11 | 47.51 | 4.15 | 0.00 | 0.00 |
| Regenerated first absorbent | 520 | 10 | 0.3 | 254983 | 14153.21 | 0.00 | 0.00 | 0.00 | 100.00 | 0.00 | 0.00 |
| Pre wash | 140 | 10 | 8 | 183 | 10.18 | 0.00 | 0.00 | 0.00 | 100.00 | 0.00 | 0.00 |
| First absorbent | 240 | 10 | 8 | 225000 | 12488.94 | 0.00 | 0.00 | 0.00 | 100.00 | 0.00 | 0.00 |
| Pressurized CO2 | 601 | 281 | 3.3 | 688 | 16.13 | 1.01 | 0.14 | 94.68 | 4.15 | 0.00 | 0.00 |
| intermediate | | | | | | | | | | | |
| Non-condensed portion | 610 | −38 | 17 | 16 | 0.47 | 34.54 | 0.00 | 65.46 | 0.00 | 0.00 | 0.00 |
| Purified CO2 | 620 | −25 | 17 | 659 | 14.97 | 0.00 | 0.00 | 100.00 | 0.00 | 0.00 | 0.00 |
| Intermediate absorbent | 322 | 10 | 4 | 30000 | 1665.19 | 0.00 | 0.00 | 0.00 | 100.00 | 0.00 | 0.00 |

| | |
|---|---|
| Methane Purity [mol %] | 98.37 |
| Methane production [kg/h] | 458.82 |
| Methane recovery [%] | 99.99 |
| CO2 production [kg/h] | 658.49 |
| CO2 recovery [%] | 97.15 |
| Total Power [kWh] | 384.58 |
| Total power [W/Nm3 biogas] | 368.02 |
| Biogas power [W/Nm3 biogas] | 248.13 |
| CO2 Power [kW/ton CO2] | 190.26 |

TABLE IV

| | | T | P | Total | Total | CH4 | H2S | CO2 | H2O | N2 | O2 |
|---|---|---|---|---|---|---|---|---|---|---|---|
| Name | Reference | [° C.] | [bar(a)] | [kg/h] | [kmol/h] | [mol %] | [mol %] | [mol %] | [mol %] | [mol %] | [mol %] |
| Biogas feed | 100 | 35 | 1.013 | 1185 | 46.63 | 61.35 | 0.05 | 33.03 | 5.55 | 0.00 | 0.00 |
| Combined feed | 101 | 10 | 7 | 1255 | 48.28 | 63.36 | 0.05 | 35.40 | 1.17 | 0.00 | 0.00 |
| Washed biogas | 110 | 7 | 6.9 | 1244 | 47.73 | 64.08 | 0.05 | 35.72 | 0.14 | 0.00 | 0.00 |
| Spent pre-wash | 120 | 10 | 6.9 | 406 | 22.46 | 0.01 | 0.00 | 0.22 | 99.74 | 0.00 | 0.00 |
| Pre wash | 140 | 5 | 8 | 395 | 21.92 | 0.00 | 0.00 | 0.04 | 99.95 | 0.00 | 0.00 |
| Upgraded biogas | 211 | 5 | 6.8 | 474 | 28.99 | 98.64 | 0.00 | 0.87 | 0.13 | 0.23 | 0.12 |
| Loaded first absorbent | 220 | 5 | 6.8 | 210797 | 11672.70 | 0.02 | 0.00 | 0.17 | 99.81 | 0.00 | 0.00 |
| Loaded second absorbent | 221 | 5 | 6.8 | 90000 | 4992.74 | 0.02 | 0.00 | 0.04 | 99.93 | 0.00 | 0.00 |
| First absorbent | 240 | 5 | 8 | 210000 | 11649.49 | 0.00 | 0.00 | 0.04 | 99.95 | 0.00 | 0.00 |
| First recovered methane | 310 | 5 | 5 | 30 | 1.18 | 66.06 | 0.03 | 33.73 | 0.18 | 0.00 | 0.00 |
| Methane lean loaded first | 320 | 5 | 5 | 210767 | 11671.53 | 0.01 | 0.00 | 0.17 | 99.82 | 0.00 | 0.00 |
| absorbent | | | | | | | | | | | |
| Lean first absorbent | 420 | 5 | 0.7 | 213695 | 11854.46 | 0.00 | 0.00 | 0.04 | 99.95 | 0.00 | 0.00 |
| Strip gas | 430 | 5 | 2.6 | 210768 | 11673.67 | 0.00 | 0.00 | 0.15 | 99.84 | 0.00 | 0.00 |
| CO2-rich intermediate | 430 | 5 | 0.7 | 719 | 17.37 | 8.24 | 0.12 | 90.37 | 1.26 | 0.00 | 0.00 |
| Non-condensed portion | 610 | −45 | 17 | 90 | 2.95 | 48.54 | 0.00 | 51.46 | 0.00 | 0.00 | 0.00 |
| Purified CO2 | 620 | −25 | 17 | 624 | 14.18 | 0.00 | 0.00 | 100.00 | 0.00 | 0.00 | 0.00 |
| Second recovered methane | 710 | 5 | 1.015 | 77 | 2.53 | 47.90 | 0.03 | 51.19 | 0.87 | 0.00 | 0.00 |
| Methane lean loaded second | 720 | 5 | 0.2 | 89923 | 4990.22 | 0.00 | 0.00 | 0.02 | 99.98 | 0.00 | 0.00 |
| absorbent | | | | | | | | | | | |
| Second spent strip gas | 810 | 5 | 1.013 | 289 | 9.57 | 0.00 | 0.02 | 9.59 | 0.88 | 70.86 | 18.65 |
| Second absorbent | 820 | 5 | 8 | 90000 | 4995.74 | 0.00 | 0.00 | 0.00 | 100.00 | 0.00 | 0.00 |
| Regenerated first absorbent | 820 | 5 | 1.013 | 89884 | 4989.32 | 0.00 | 0.00 | 0.00 | 100.00 | 0.00 | 0.00 |
| Second strip gas | 830 | 24 | 1.05 | 250 | 8.67 | 0.00 | 0.00 | 0.00 | 0.00 | 79.00 | 21.00 |
| Washed non-condensed | 910 | 6 | 17 | 27 | 1.48 | 92.39 | 0.00 | 7.54 | 0.05 | 0.00 | 0.00 |
| portion | | | | | | | | | | | |
| Loaded third absorbent | 920 | 6 | 17 | 3563 | 195.63 | 0.03 | 0.00 | 0.76 | 99.20 | 0.00 | 0.00 |
| Third absorbent | 940 | 5 | 19 | 3500 | 194.16 | 0.00 | 0.00 | 0.04 | 99.95 | 0.00 | 0.00 |

| | |
|---|---|
| Methane Purity [mol %] | 98.64 |
| Methane production [kg/h] | 458.81 |
| Methane recovery [%] | 99.99 |
| CO2 production [kg/h] | 624.07 |
| CO2 recovery [%] | 92.07 |
| Total Power [kWh] | 375.68 |
| Total power [W/Nm3 biogas] | 359.50 |
| Biogas power [W/Nm3 biogas] | 250.86 |
| CO2 Power [kW/ton CO2] | 178.12 |

TABLE V

| | | T | P | Total | Total | CH4 | H2S | CO2 | H2O | N2 | O2 |
|---|---|---|---|---|---|---|---|---|---|---|---|
| Name | Reference | [° C.] | [bar(a)] | [kg/h] | [kmol/h] | [mol %] | [mol %] | [mol %] | [mol %] | [mol %] | [mol %] |
| Biogas feed | 100 | 35 | 1.013 | 1185 | 46.63 | 61.35 | 0.05 | 33.03 | 5.55 | 0.00 | 0.00 |
| Combined feed | 101 | 10 | 7 | 1300 | 50.16 | 63.52 | 0.05 | 35.06 | 1.16 | 0.19 | 0.01 |
| Washed biogas | 110 | 10 | 6.9 | 1289 | 49.61 | 64.21 | 0.05 | 35.36 | 0.18 | 0.19 | 0.01 |
| Spent pre-wash | 120 | 10 | 6.9 | 401 | 22.15 | 0.01 | 0.00 | 0.21 | 99.75 | 0.00 | 0.00 |
| Pre wash | 140 | 10 | 8 | 389 | 21.61 | 0.00 | 0.00 | 0.03 | 99.97 | 0.00 | 0.00 |
| Upgraded biogas | 211 | 5 | 6.8 | 480 | 29.14 | 97.87 | 0.00 | 1.16 | 0.13 | 0.65 | 0.19 |
| Loaded first absorbent | 220 | 10 | 6.8 | 250809 | 13894.33 | 0.02 | 0.00 | 0.14 | 99.84 | 0.00 | 0.00 |
| Loaded second absorbent | 221 | 5 | 6.8 | 70000 | 3883.91 | 0.02 | 0.00 | 0.03 | 99.94 | 0.00 | 0.00 |
| First absorbent | 240 | 10 | 8 | 250000 | 13872.16 | 0.00 | 0.00 | 0.03 | 99.97 | 0.00 | 0.00 |
| First recovered methane | 310 | 10 | 3.5 | 118 | 4.16 | 55.58 | 0.04 | 43.93 | 0.36 | 0.08 | 0.01 |
| Methane lean loaded first | 320 | 10 | 1.65 | 250816 | 13897.11 | 0.00 | 0.00 | 0.13 | 99.87 | 0.00 | 0.00 |
| absorbent | | | | | | | | | | | |
| Lean first absorbent | 420 | 10 | 0.6 | 250189 | 13882.67 | 0.00 | 0.00 | 0.03 | 99.97 | 0.00 | 0.00 |
| Strip gas | 430 | 5 | 2 | 25 | 0.87 | 0.00 | 0.00 | 0.00 | 0.00 | 79.00 | 21.00 |
| CO2-rich intermediate | 430 | 10 | 0.6 | 651 | 15.31 | 0.48 | 0.13 | 92.11 | 2.07 | 4.16 | 1.02 |
| Gas feed to pre-liquefaction | 601 | 35 | 3.3 | 651 | 15.31 | 0.48 | 0.13 | 92.11 | 2.07 | 4.16 | 1.02 |
| stripper | | | | | | | | | | | |
| Enriched liquefaction feed | 602 | 5 | 3 | 813 | 19.19 | 1.58 | 0.11 | 90.52 | 0.30 | 4.93 | 2.57 |
| Non-condensed portion | 610 | −38 | 17 | 199 | 5.18 | 5.84 | 0.00 | 66.44 | 0.00 | 18.23 | 9.50 |
| Purified CO2 | 620 | −24 | 17 | 613 | 13.92 | 0.00 | 0.00 | 100.00 | 0.00 | 0.00 | 0.00 |
| Second recovered methane | 710 | 5 | 1.0135 | 34 | 1.41 | 67.03 | 0.03 | 25.34 | 0.87 | 6.47 | 0.26 |
| Second spent strip gas | 810 | 5 | 1.0135 | 1044 | 35.84 | 0.02 | 0.01 | 2.56 | 0.87 | 76.31 | 20.22 |
| Second absorbent | 820 | 5 | 8 | 70000 | 3885.60 | 0.00 | 0.00 | 0.00 | 100.00 | 0.00 | 0.00 |
| Regenerated first absorbent | 820 | 5 | 1.0135 | 69925 | 3881.43 | 0.00 | 0.00 | 0.00 | 100.00 | 0.00 | 0.00 |
| Second strip gas | 830 | 24 | 1.05 | 1000 | 34.66 | 0.00 | 0.00 | 0.00 | 0.00 | 79.00 | 21.00 |
| Washed non-condensed | 910 | 5 | 17 | 32 | 1.04 | 7.10 | 0.02 | 16.73 | 0.05 | 61.06 | 15.03 |
| portion | | | | | | | | | | | |
| Loaded third absorbent | 920 | 5 | 17 | 47687 | 2631.43 | 0.01 | 0.00 | 0.40 | 99.57 | 0.01 | 0.01 |
| Third absorbent | 940 | 5 | 18 | 47520 | 2627.28 | 0.00 | 0.00 | 0.28 | 99.72 | 0.00 | 0.00 |
| Regenerated third absorbent | 940 | 5 | 3 | 47520 | 2627.28 | 0.00 | 0.00 | 0.28 | 99.72 | 0.00 | 0.00 |

| | |
|---|---|
| Methane Purity [mol %] | 97.87 |
| Methane production [kg/h] | 457.51 |
| Methane recovery [%] | 99.70 |
| CO2 production [kg/h] | 612.75 |
| CO2 recovery [%] | 90.40 |
| Total Power [kWh] | 408.96 |
| Total power [W/Nm3 biogas] | 391.35 |
| Biogas power [W/Nm3 biogas] | 282.13 |
| CO2 Power [kW/ton CO2] | 186.27 |

### LIST OF REFERENCE NUMERALS

10 Pre-washer
100 Biogas feed
101 Combined biogas feed
110 Washed biogas feed
120 Spent pre-wash liquid
140 Pre-wash liquid
20 First absorber
21 Second absorber
210 Enriched biogas/upgraded biogas
211 Upgraded biogas
220 Loaded first absorbent
221 Loaded second absorbent
240 First absorbent
30 Flash separation
31, 32 Methane recovery unit
3a-3c First recovery step variations
310 First recovered methane portion
311 Intermediate recovered gas
320 Loaded
321 Methane-lean loaded first absorbent
322 Intermediate absorbent
40 Low-pressure desorption unit
41 Flash separator
410 Carbon dioxide-rich intermediate
420 Lean first absorbent
430 Strip gas
440 Liquid feed to low-pressure desorption column
50 First stripper
510 Spent first strip gas
520 Regenerated first absorbent
530 First strip gas
60 Liquefaction process
601 Pressurized carbon dioxide-rich intermediate
602 Enriched liquefaction feed
610 Non-condensed portion
620 Purified carbon dioxide
61 Vacuum pump
62, 65, 67 Heat exchanger/chiller
671 Stripping gas
63, 66 Separation vessels
632, 662 Condensed water
64 Compressor
661 Purification step
664 Impurities
68 Stripper
69 Condensor
692 Condensed portion
7a-7c Second methane step variations
71 Second methane recovery step
710 Second recovered methane portion
720 Methane-lean loaded second absorbent
730 External gas
80 Second stripper
810 Spent second strip gas
820 Regenerated second absorbent
830 Second strip gas
90 Post-liquefaction absorber
91 Pre-liquefaction stripper
910 Washed non-condensed portion
920 Loaded third absorbent
940 Second absorbent

What is claimed is:

1-17. (canceled)

18. A method for treating a biogas feed comprising methane and carbon dioxide to provide an upgraded biogas and a purified carbon dioxide product, which method comprises the steps of:
i) in a first absorption step, contacting the biogas feed with a first absorbent in a first absorber thereby providing an enriched biogas and a loaded first absorbent, the loaded first absorbent having a higher content of carbon dioxide than the first absorbent,
ii) in a vacuum desorption step, feeding the loaded first absorbent to a low-pressure desorption unit with an operating pressure which is lower than ambient pressure providing a carbon dioxide-rich intermediate and a lean first absorbent, and optionally,
iii) in a liquefaction step, liquefying the carbon dioxide-rich intermediate in a liquefaction process thereby providing the purified carbon dioxide product and a non-condensed portion,
wherein the first absorbent is a physical absorbent, preferably water, and further wherein the first absorbent is obtained from the lean first absorbent.

19. The method according to claim 18, which method further comprises a step of:
in a first methane recovery step, recovering methane from the loaded first absorbent prior to the vacuum desorption step ii), optionally by flashing the loaded first absorbent, providing a first recovered methane portion and a methane-lean loaded first absorbent,
wherein the methane-lean loaded first absorbent replaces the loaded first absorbent in the vacuum desorption step ii) and has lower content of methane than the loaded first absorbent.

20. The method according to 19, wherein the first methane recovery step comprises:
flashing the loaded first absorbent in a methane recovery unit and contacting the resulting liquid portion with an intermediate recovered gas in the methane recovery unit,
obtaining, from the methane recovery unit, the first recovered me-thane portion and an intermediate methane-lean loaded first absorbent,
flashing the intermediate methane-lean loaded first absorbent thereby providing the methane-lean first absorbent and the intermediate re-covered gas,
pressurizing and feeding the intermediate recovered gas to the me-thane recovery unit.

21. The method according to claim 20, wherein the first methane recovery step further comprises:
contacting the gas of the methane recovery unit with an intermediate absorbent providing the first recovered methane portion,
wherein the intermediate absorbent is obtained from the lean first absorbent.

22. The method according to claim 18, wherein the vacuum desorption step ii) comprises contacting the loaded first absorbent, or methane-lean loaded absorbent if present, with a strip gas in the low-pressure desorption unit providing the carbon dioxide-rich intermediate and the lean first absorbent, the carbon dioxide-rich intermediate having a higher content of carbon dioxide than the strip gas.

23. The method according to claim 22, wherein the strip gas of step ii) is obtained by flashing the loaded first absorbent, or the methane-lean loaded first absorbent if present, upstream of the low-pressure desorption unit.

24. The method according to claim 22, wherein the strip gas of step ii) is a gas which allows carbon dioxide to be stripped in the low-pressure desorption unit, such as air, nitrogen, or methane.

25. The method according to claim 18, which method comprises liquefaction step iii) and further comprises recycling the non-condensed portion to the first absorber.

26. The method according to claim 18, which method comprises liquefaction step iii) and further comprises the steps of:
in a post-liquefaction absorption step, contacting the non-condensed portion obtained in step iii) with a third absorbent in a post-liquefaction absorber thereby providing a washed non-condensed portion and a loaded third absorbent, the washed non-condensed portion having a lower content of carbon dioxide than the non-condensed portion, and either
obtaining the third absorbent from the lean first absorbent and recycling the loaded third absorbent to the low-pressure desorption unit, or
contacting the loaded third absorbent with the carbon dioxide rich intermediate in a pre-liquefaction stripper, thereby providing the third absorbent and an enriched liquefaction feed for use in the liquefaction step iii).

27. The method according to claim 18, wherein the enriched biogas obtained in step i) is the upgraded biogas and wherein the method further comprises the steps of:
iv) in a first stripping step, contacting the lean first absorbent obtained from step ii) with a first strip gas in a first stripper providing a spent first strip gas and regenerated first absorbent,
wherein the first absorbent is a portion of the regenerated first absorbent and the intermediate absorbent, if present, and/or the third absorbent, if present, is/are (a) further portion(s) of the regenerated first absorbent.

28. The method according to claim 27, wherein:
the first strip gas is at least a portion of the first recovered methane portion or of the upgraded biogas and the spent first strip gas is recycled to the first absorber.

29. The method according to claim 18, wherein the method further comprises the steps of:
v) in a second absorption step, contacting the enriched biogas obtained in step i) with a second absorbent in a second absorber providing the upgraded biogas and a loaded second absorbent,
vi) in a second methane recovery step, recovering methane from the loaded second absorbent obtained in step v) providing a second recovered methane portion and a methane-lean loaded second absorbent, and
vii) in a second stripping step, contacting the methane-lean loaded second absorbent with a second strip gas in a second stripper providing a spent second strip gas and a regenerated second absorbent, wherein the spent second strip gas has a higher content of carbon dioxide than the second strip gas,
wherein the second absorbent is a physical absorbent and is obtained from the regenerated second absorbent, and optionally,
further wherein the first absorbent is a portion of the lean first absorbent obtained from step ii) and the intermediate absorbent, if present, and/or the third absorbent, if present, is/are (a) further portion(s) of is a portion of the lean first absorbent.

30. The method according to claim 29, wherein the second strip gas is at least a portion of the upgraded biogas or of the enriched biogas, and the spent second strip gas is recycled to the first absorber.

31. The method according to claim 29, wherein the method further comprises flashing the methane-lean loaded second absorbent and feeding the gas thus obtained to the carbon dioxide intermediate.

32. The method according to claim 18, further comprising, prior to the first absorption step, a pre-wash step of the biogas feed:
in the pre-wash step, contacting the biogas feed with a pre-wash liquid in a pre-wash unit, thereby providing a spent pre-wash liquid and a washed biogas feed,
wherein the spent pre-wash liquid is discarded or regenerated by heat treatment, the pre-wash liquid is a physical absorbent, and the washed biogas feed is sent to the first absorber.

33. A method for recovering carbon dioxide from a combined biogas up-grading process and carbon dioxide liquefaction process, which method comprises the steps of
a) obtaining a carbon dioxide rich liquefaction feed from the biogas upgrading process, which biogas upgrading process removes carbon dioxide from a biogas feed,
b) liquifying the carbon dioxide-rich feed in the liquefaction process thereby providing a purified carbon dioxide product and a non-condensed portion,
c) contacting the non-condensed portion obtained in step b) with a physical absorbent in a post-liquefaction absorber thereby providing a washed non-condensed portion and a loaded physical absorbent, the washed non-condensed portion having a lower content of carbon dioxide than the non-condensed portion,
d) regenerating the loaded physical absorbent to release carbon dioxide therefrom and recycling the released carbon dioxide into the carbon dioxide rich liquefaction feed obtained from the biogas upgrading process.

34. The method for recovering carbon dioxide according to claim 33, wherein step d) comprises:
contacting the loaded physical absorbent with the carbon dioxide rich feed in a pre-liquefaction stripper, prior to the liquefaction process in step b), thereby providing the physical absorbent and an enriched liquefaction feed for step b), or
sending the loaded physical absorbent to the biogas upgrading process for regeneration in a desorption unit, which desorption unit provides the carbon dioxide rich liquefaction feed.
